(19) United States
(12) Patent Application Publication
(10) Pub. No.: US 2012/0295641 A1
(43) Pub. Date: Nov. 22, 2012

(54) WIRELESS COMMUNICATION DEVICE, INFORMATION PROCESSING DEVICE, COMMUNICATION SYSTEM, AND LOCATION DETERMINATION METHOD

(75) Inventor: Shinichiro Tsuda, Kanagawa (JP)

(73) Assignee: Sony Corporation, Tokyo (JP)

(21) Appl. No.: 13/457,696

(22) Filed: Apr. 27, 2012

(30) Foreign Application Priority Data
May 19, 2011 (JP) 2011-111949

(51) Int. Cl. H04W 4/02

(52) U.S. Cl. 455/456.6

(57) ABSTRACT

A detection unit detects an error of second location information by designating first location information periodically or aperiodically acquired on the basis of information from an artificial satellite, designating the second location information periodically or aperiodically acquired on the basis of information from a base station serving as a connection target, and comparing the second location information to the first or second location information acquired at a timing before an acquisition time of the second location information on a time axis. A determination unit determines a current location based on the first or second location information, and determines the current location based on other location information specified by a base station related to the second location information when the first location information has not been acquired at a timing of the determination and the error of the second location information acquired at the timing of the determination has been detected.

### BACKGROUND

The present disclosure relates to a wireless communication device, and more particularly to a wireless communication device, an information processing device, a communication system, and a location determination method, which determine a location of a wireless communication device.

Recently, with the expansion of wireless communication networks, services for wireless communication devices have been expanded. For example, navigation services using current locations of wireless communication devices are widely used as the services for the wireless communication devices.

In order to use the services as described above, the wireless communication devices need to acquire the current locations. In general, a global positioning system (GPS) reception function of receiving a signal from an artificial satellite and calculating the current location is used as a function of acquiring the current location.

In the GPS reception function, electric waves transmitted from a plurality of artificial satellites are received, so that a current location is calculated on the basis of a difference between a transmission time of each electric wave from an artificial satellite and a reception time when the wireless communication device receives each electric wave (for example, see Japanese Patent Application Laid-Open No. 2009-243946).

### SUMMARY

In the above-described related art, it may be impossible to calculate the current location when no signal is received from the artificial satellite. For example, the current location of the wireless communication device may be acquired using a location of a base station by associating identification information of the base station with the location of the base station. For example, on the basis of the identification information of the base station connected to the wireless communication device, the location of the base station to which connection is in progress is acquired and the acquired location can be designated as the current location of the wireless communication device.

However, a relationship between the base station and the location may also change due to movement or change of the base station. In this case, the association between the identification information of the base station and the location of the base station becomes inappropriate, so that the wireless communication device may not be able to acquire appropriate location information.

It is desirable to acquire appropriate location information.

According to first embodiments of the present technology, there are provided a wireless communication device and a location determination method including: a detection unit for detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and a determination unit for determining a current location based on the first or second location information, and determining the current location based on other location information specified by a base station related to the second location information when the first location information has not been acquired at a timing of the determination and the error of the second location information acquired at the timing of the determination has been detected. Thereby, it is possible to determine the current location based on the other location information specified by the base station related to the second location information when the first location information has not been acquired and the error of the second location information acquired at the timing of the determination of the current location has been detected.

In addition, in the first embodiments, information from a base station serving as the connection target may be identification information of the base station. The wireless communication device and the location determination method may further include: an acquisition unit for acquiring, as the other location information, location information associated with the identification information of the base station related to the second location information of which an error has been detected by the detection unit from a correction database (DB) in which the identification information and the location information are associated and recorded. Thereby, it is possible to acquire the other location information from the correction DB.

In addition, in the first embodiments, the wireless communication device and the location determination method may further include: a generation unit for generating the other location information using the first or second location information acquired at the timing before the timing of the determination when the acquisition unit is not able to acquire the other location information from the correction DB. Thereby, it is possible to generate the other location information using the first or second location information acquired at the timing before the timing of the determination when the acquisition unit is not able to acquire the other location information from the correction DB.

In addition, in the first embodiments, the generation unit may generate the other location information using latest location information among pieces of the first and second location information acquired at the timing before the timing of the determination. Thereby, it is possible to cause the other location information to be generated using the latest location information among the pieces of the first and second location information.

In the first embodiments, the generation unit may generate the other location information based on latest first location information if a moving distance of the wireless communication device from an acquisition time of the latest first location information among pieces of the first location information acquired until the timing of the determination till the timing of the determination is short on the basis of a threshold value, and generate the other location information using latest second location information among pieces of the second location information acquired at the timing before the acquisition time of the second location information acquired at the timing of the determination if the moving distance is long on the basis of the threshold value. Here, the case where the moving distance is long on the basis of the threshold value includes the meanings of both the case where the moving distance is greater than or equal to the threshold value and the case where the moving distance is greater than the threshold value. In addition, the case where the moving distance is short on the basis of the threshold value includes the meanings of both the case where the moving distance is less than or equal to the threshold value and the case where the moving distance is less than the threshold value. However, when the case where the moving distance is long on the basis of the threshold value means that the moving distance is greater than or equal to the threshold value, the case where the moving distance is short on the basis of the threshold value means that the moving distance is less than the threshold value. On the other hand, when the case where the moving distance is long on the basis of the threshold value means that the moving distance is greater than the threshold value, the case where the moving distance is short on the basis of the threshold value means that the moving distance is less than or equal to the threshold value. Thereby, it is possible to generate the other location information based on the latest first location information if the moving distance of the wireless communication device from the acquisition time of the latest first location information to the timing of the determination of the current location is less than or equal to the threshold value and generate the other location information using the latest second location information if the moving distance exceeds the threshold value.

In addition, in the first embodiments, the generation unit may update the correction DB by associating and newly recording the generated other location information and the identification information related to the other location information. Thereby, it is possible to cause the correction DB to be updated.

In addition, in the first embodiments, the correction DB may have attribute information, indicating the first or second location information used when the location information has been generated, associated and recorded for each piece of identification information, and the generation unit may generate the other location information using the first location information acquired within a predetermined distance from a location of the wireless communication device at the timing of the determination among pieces of the first location information acquired at the timing before the acquisition time of the second location information acquired at the timing of the determination when the attribute information associated with the other location information acquired by the acquisition unit indicates the second location information, and update the correction DB by associating and newly recording the other location information, the identification information related to the other location information, and the attribute information. Thereby, it is possible to cause the location information related to the base station specified by the other location information to be updated using the first location information when the other location information generated on the basis of the second location information is acquired.

In the first embodiments, the correction DB may have signal strength information indicating strength of a radio signal from a base station, the signal strength information being further associated with each piece of the identification information associated with the attribute information indicating the first location information, and the generation unit may generate the other location information using the first location information acquired within a predetermined distance from a location of the wireless communication device at the timing of the determination if signal strength is high at the timing of the determination on the basis of the signal strength indicated by the signal strength information associated with the other location information acquired by the acquisition unit, and update the correction DB by associating and newly recording the other location information, the identification information related to the other location information, the attribute information, and the signal strength information when the first location information has been generated. Here, the case where the signal strength is high on the basis of signal strength includes the meanings of both the case where the signal strength is greater than or equal to others and the case where the signal strength is greater than others. Thereby, it is possible to perform an update using the first location information acquired at the location where the strength of the radio signal from the base station is higher among pieces of the first location information related to the base station specified by the other location information when the other location information generated on the basis of the first location information has been acquired.

In addition, in the first embodiments, the acquisition unit may acquire the other location information from a correction information server retaining the correction DB. Thereby, it is possible to cause the other location information to be acquired from the correction information server.

In addition, in the first embodiments, the acquisition unit may acquire the other location information from the correction DB recorded in a storage unit embedded in or attached to the wireless communication device. Thereby, it is possible to cause the other location information to be acquired from the correction DB recorded in the storage unit embedded in or attached to the wireless communication device.

In addition, in the first embodiments, the determination unit may correct the second location information according to the other location information acquired on the basis of the identification information of the base station related to the second location information of which an error has been detected by the detection unit, and determine the current location using the corrected second location information. Thereby, it is possible to cause the current location to be determined using the corrected second location information.

In addition, in the first embodiments, the detection unit may calculate a distance and an elapsed time between the second location information acquired at the timing of the determination and latest location information among pieces of the first and second location information acquired at the timing before the timing of the determination, and determine that the second location information acquired at the timing of the determination is wrong if the distance is greater than a threshold value on the basis of the threshold value set according to the elapsed time. Here, the case where the distance is long on the basis of the threshold value includes the meanings of both the case where the distance is greater than or equal to the threshold value and the case where the distance is greater than the threshold value. Thereby, it is possible to determine that the second location information is wrong if the distance between the latest location information among the pieces of the first and second location information acquired at the timing before the timing of the determination and the second location information acquired at the timing of the determination is greater than the threshold value set according to the elapsed time.

In addition, in the first embodiments, the wireless communication device and the location determination method may further include: a first acquisition unit for acquiring the first location information; and a second acquisition unit for acquiring the second location information only when the first acquisition unit is not able to acquire the first location information. Thereby, it is possible to acquire the second location information only when the first acquisition unit is not able to acquire the first location information.

According to a second embodiment of the present technology, there is provided an information processing device including: an acquisition unit for acquiring location information including at least one of pieces of first location information periodically or aperiodically generated on the basis of information from an artificial satellite and second location information periodically or aperiodically generated on the basis of information from a base station serving as a connection target from a wireless communication device; a detection unit for detecting an error of the second location information by comparing the second location information among pieces of the location information acquired by the acquisition unit to the first or second location information acquired at a timing before an acquisition time of the second location information on a time axis; a correction unit for correcting the second location information of which the error has been detected on the basis of other location information specified by a base station related to the second location information when the detection unit has detected the error; and a recording unit for recording the location information acquired by the acquisition unit as a history and recording the second location information corrected by the correction unit as the history when the error has been detected by the detection unit. Thereby, it is possible to detect the error of the second location information in the information processing device acquiring the location information including at least one of pieces of the first and second location information, correct the error according to the other location information, and record a correction result.

In addition, according to a third embodiment of the present technology, there is provided an information processing device including: a reception unit for receiving a correction information request from a wireless communication device, which detects an error of second location information, when the wireless communication device has detected the error by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and a providing unit for providing the wireless communication device with location information retained in association with a base station related to the second location information as correction information when the correction information request has been received. Thereby, it is possible to cause the correction information to be provided to the wireless communication device in which the first location information has not been acquired and the error of the second location information acquired at the timing of the determination of the current location has been detected.

In addition, according to a fourth embodiment of the present technology, there is provided a communication system including: a wireless communication device including a detection unit for detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and a determination unit for determining a current location based on the first or second location information, and determining the current location based on other location information specified by a base station related to the second location information when the first location information has not been acquired at a timing of the determination and the error of the second location information acquired at the timing of the determination has been detected; and a server for providing the wireless communication device with substitute location information for a location of the base station indicated by the second location information as the other location information on the basis of a correction information request command provided when the error has been detected by the wireless communication device. Thereby, it is possible to cause the current location to be determined on the basis of the other location information specified by the base station related to the second location information when the first location information has not been acquired and the error of the second location information acquired at the timing of the determination of the current location has been detected.

According to the embodiments of the present technology described above, it is possible to obtain excellent effects by which appropriate location information can be acquired.

### BRIEF DESCRIPTION OF THE DRAWINGS

FIG. 1 is a diagram conceptually illustrating a method of acquiring location information according to an embodiment of the present technology;

FIG. 2 is a diagram schematically illustrating an example of a location display in which association of a cell identifier (ID) and location information is wrong when location information is acquired on the basis of cell IDs;

FIG. 3 is a block diagram illustrating a configuration example of a wireless communication device 200 according to a first embodiment of the present technology;

FIG. 4 is a simplified diagram illustrating examples of a DB retained in a server 180 and a correction DB retained in a correction information retention unit 270 according to the first embodiment of the present technology;

FIG. 5 is a flowchart illustrating an example of a current location determination processing procedure when a wireless communication device 200 determines a current location according to the first embodiment of the present technology, and illustrates one operation in which the current location is determined;

FIG. 6 is a block diagram illustrating a configuration example of a wireless communication device 300 according to a second embodiment of the present technology;

FIG. 7 is a flowchart illustrating an example of a current location determination processing procedure in which the wireless communication device 300 determines a current location according to the second embodiment of the present technology;

FIG. 8 is a flowchart illustrating an example of a processing procedure of a correction information acquisition process (step S920) in the current location determination processing procedure of the second embodiment of the present technology;

FIG. 9 is a block diagram illustrating a configuration example of a wireless communication device 400 according to a third embodiment of the present technology;

FIG. 10 is a flowchart illustrating an example of a current location determination processing procedure in which the wireless communication device 400 determines a current location according to the third embodiment of the present technology;

FIG. 11 is a flowchart illustrating an example of a processing procedure of a correction information acquisition process (step S940) in the current location determination processing procedure of the third embodiment of the present technology;

FIG. 12 is a block diagram illustrating a configuration example of a communication system 501 including a wireless communication device 510 corresponding to the wireless communication device 200 of the first embodiment of the present technology according to a fourth embodiment of the present technology;

FIG. 13 is a block diagram illustrating a configuration example of a communication system 502 including a wireless communication device 520 corresponding to the wireless communication device 300 of the second embodiment of the present technology according to the fourth embodiment of the present technology;

FIG. 14 is a block diagram illustrating a configuration example of a communication system 503 including a wireless communication device 530 corresponding to the wireless communication device 300 of the third embodiment of the present technology according to the fourth embodiment of the present technology;

FIG. 15 is a block diagram illustrating a configuration example of a communication system 504 in which a correction DB is updated according to correction information generated by a wireless communication device closer to a base station in the fourth embodiment of the present technology;

FIG. 16 is a diagram illustrating an example in which a correction DB is updated according to correction information generated by a wireless communication device 540 closer to a base station in the fourth embodiment of the present technology;

FIG. 17 is a flowchart illustrating an example of a processing procedure of a correction information acquisition process (step S950) in a current location determination processing procedure of the wireless communication device 540 of the fourth embodiment of the present technology;

FIG. 18 is a flowchart illustrating an example of a processing procedure of a correction server-retained information acquisition/update process (step S960) in the current location determination processing procedure of the wireless communication device 540 of the fourth embodiment of the present technology;

FIG. 19 is a block diagram illustrating a configuration example of a communication system 602 in which a server performs a location correction function of the wireless communication device 200 of the first embodiment of the present technology according to a fifth embodiment of the present technology;

FIG. 20 is a block diagram illustrating a configuration example of a communication system 603 in which the server performs a location correction function of the wireless communication device 300 of the second embodiment of the present technology according to the fifth embodiment of the present technology;

FIG. 21 is a block diagram illustrating a configuration example of a communication system 605 in which the server performs a location correction function of the wireless communication device 400 of the third embodiment of the present technology according to the fifth embodiment of the present technology;

FIG. 22 is a block diagram illustrating a configuration example of a communication system 606 in which the server performs a location correction function of the wireless communication device 540 of the fourth embodiment of the present technology according to the fifth embodiment of the present technology; and

FIG. 23 is a block diagram illustrating a configuration example of a wireless communication device 700 of a sixth embodiment of the present technology.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of the present technology will be described. Description will be given in the following order.

1. Outline of Location Information Acquisition in Mobile Terminal

2. Background for Embodiments of Present Technology

3. First Embodiment (Example in which Location Information of which Error has been Detected among Pieces of Location Information Acquired from Cell ID is Corrected Using Correction DB)

4. Second Embodiment (Current Location Determination Control: Example in which Correction Information is Generated for Location Information of which Error has been Detected)

5. Third Embodiment (Current Location Determination Control: Example in which Location to be Referred to is Determined and Generated on Basis of Moving Distance of Wireless Communication Device when Correction Information is Generated for Location Information of which Error has been Detected)

6. Fourth Embodiment (Current Location Determination Control: Example in which Server Retaining Correction DB is Provided)

7. Fifth Embodiment (Location Information Correction Control: Example in which Location Information Transmitted from Wireless Communication Device is Corrected)

8. Sixth Embodiment (Current Location Determination Control: Example in which Wireless Communication Device Retains Location Information Associated with Cell ID)

### 1. Outline of Location Information Acquisition in Mobile Terminal

First, acquisition of location information in a wireless communication device will be described.

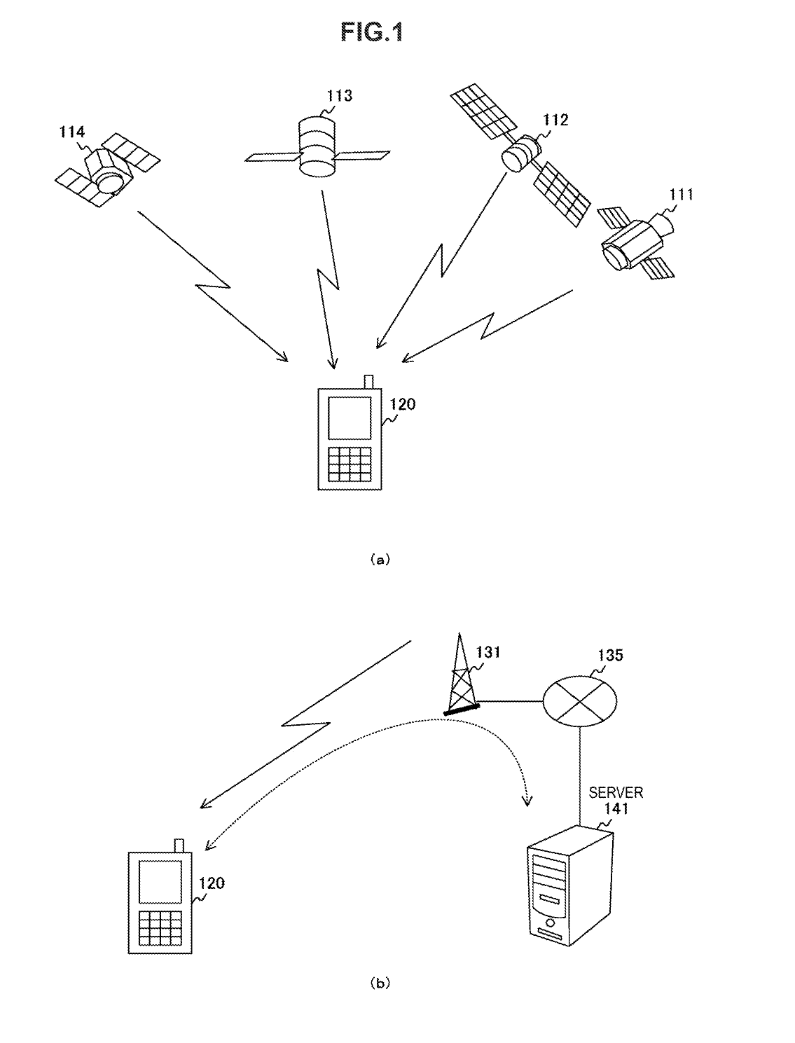

FIG. 1 is a diagram conceptually illustrating a method of acquiring location information according to an embodiment of the present technology. A method of acquiring location information when a GPS signal can be received is illustrated in FIG. 1(a), and a method of acquiring location information when no GPS signal can be received is illustrated in FIG. 1(b). In FIG. 1, a mobile terminal (for example, a mobile phone 120) will be described as a wireless communication device.

In FIGS. 1(a) and 1(b), the mobile phone 120 is illustrated as the wireless communication device that acquires location information. In addition, in FIG. 1(a), artificial satellites (GPS satellites 111 to 114) that transmit GPS signals are illustrated. In addition, in FIG. 1(b), a wireless base station (base station 131) of the mobile phone, a public network 135, and a server (server 141) retaining location information (longitude and latitude) of the base station along with an ID (cell ID) unique to the base station are illustrated.

The mobile phone 120 can acquire location information with a location accuracy of several meters to several tens of meters in an environment (corresponding to FIG. 1(a)) in which signals can be received from the GPS satellites 111 to 114. However, the mobile phone 120 is not constantly used in a place where a GPS signal can be received, and is also used in environments in which no GPS signal can be received such as underground or indoors. In such an environment, the mobile phone 120 acquires location information via a unique ID (cell ID) allocated to the base station. For example, there is provided a server (server 141), which retains a DB in which cell IDs are associated with location information. The mobile phone 120 transmits a cell ID of a base station to/from which a signal is transmitted/received to the server 141. Thereafter, the server 141 provides the mobile phone 120 with location information corresponding to the cell ID, and the mobile phone 120 acquires the location information (the base station's location).

As described above, there are a method using a GPS signal and a method using an ID (cell ID) of a base station for acquisition of location information in a wireless communication device.

### 2. Background for Embodiments of Present Technology

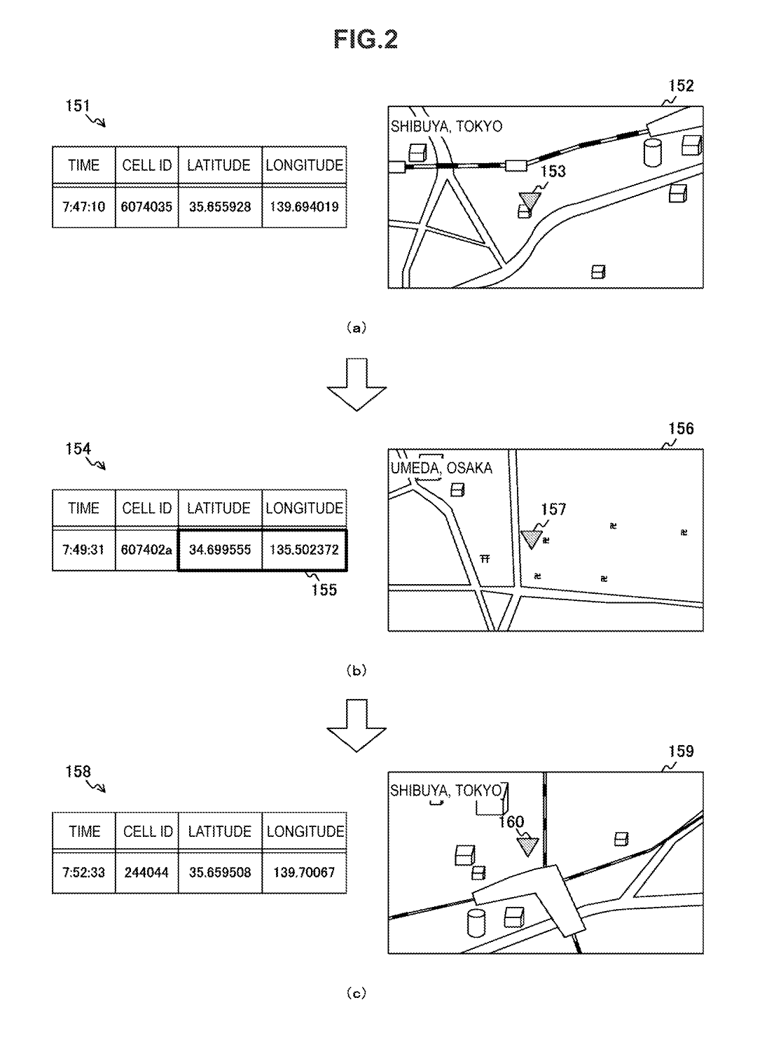

Next, the background for the embodiments of the present technology will be described with reference to FIG. 2.

FIG. 2 is a diagram schematically illustrating an example of a location display in which association of a cell ID and location information is wrong when location information is acquired on the basis of cell IDs.

In FIG. 2, it is assumed that a user of the mobile phone 120 (see FIG. 1) is moving toward Shibuya Station in Tokyo and location information is acquired using a cell ID at three continuous times “7:47:10,” “7:49:31,” and “7:52:33” on the time axis. In FIG. 2, the association of location information of a cell ID (607402a) of a base station with which communication is in progress at the time “7:49:31” is assumed to be wrong on the server.

In FIG. 2(a), a table (table 151) indicating location information acquired at the time “7:47:10” and an image (image 152) displayed on the basis of the acquired location information are illustrated.

At the time “7:47:10,” the mobile phone 120 transmits a cell ID (6074035) of a base station with which communication is in progress to the server 141. The server 141 provides the mobile phone 120 with location information (latitude “35.655928” and longitude “139.694019”) associated with the cell ID (6074035). The mobile phone 120 receiving the location information generates the image (image 152) of a map including a mark (mark 153) indicating a current location (base station's location) on the basis of the provided location information, and displays the image 152.

In FIG. 2(b), a table (table 154) indicating location information acquired at the time “7:49:31” and an image (image 156) displayed on the basis of the acquired location information are illustrated.

At the time “7:49:31,” the mobile phone 120 transmits the cell ID (607402a) of the base station with which communication is in progress to the server 141. The image 156 is generated on the basis of location information provided from the server 141 and displayed on a display screen. In this process, wrong location information is provided to the mobile phone 120 if location information (see a black frame 155 of FIG. 2(b)) associated with the cell ID (607402a) in the server 141 is wrong. On the basis of the wrong location information, the mobile phone 120 generates an image (image 156) of a map including a mark 157, and displays the image on the display screen. Thereby, the user is supposed to be in the vicinity of Shibuya Station, but an entirely different location (a point in Umeda in Osaka in FIG. 2(b)) indicated by the wrong location information is displayed on the display screen. That is, the display screen is displayed as if the current location has suddenly flown to a separate place.

In FIG. 2(c), a table (table 158) indicating location information acquired at the time “7:52:33” and an image (image 159) displayed on the basis of the acquired location information are illustrated.

At the time “7:52:33,” the mobile phone 120 transmits a cell ID (244044) of a base station with which communication is in progress to the server 141. On the basis of the location information provided from the server 141, the image 159 including a mark 160 is generated and displayed on the display screen. Because right location information is associated with the cell ID (244044), the mobile phone 120 generates an image of a map (image 159) in the vicinity of Shibuya Station, and displays the generated image. That is, the display screen is displayed as if the current location has suddenly flown and returned to a normal location.

If a cell ID is associated with wrong location information as described above, there is a problem in that the wrong location information is provided to the user. In particular, if a communication provider installs a wireless base station and a separate service provider provides location information, an update of the location information may not keep up with that of the wireless base station and wrong location information may be associated.

If the location information acquired on the basis of the cell ID is wrong, it is necessary to specify the location information without use of the wrong location information. In the embodiments of the present technology, a mobile terminal (wireless communication device) having the above-described function will be described.

### 3. First Embodiment

### Configuration Example of Wireless Communication Device

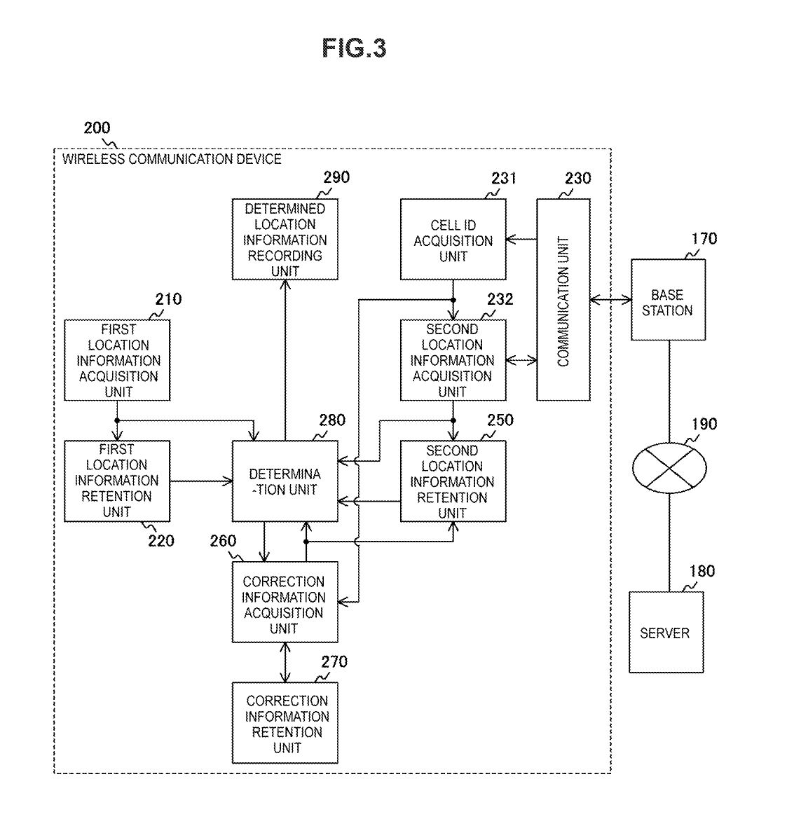

FIG. 3 is a block diagram illustrating a configuration example of a wireless communication device 200 according to a first embodiment of the present technology.

In FIG. 3, in addition to the wireless communication device 200, a base station (base station 170) that wirelessly communicates with the wireless communication device 200, a server (server 180) that retains a DB in which identification information (for example, cell IDs) indicating base stations is associated with location information, and a public network 190 are illustrated.

The wireless communication device 200 is a mobile communication device (for example, a mobile phone or a smart phone) having a GPS function. The wireless communication device 200 includes a first location information acquisition unit 210, a first location information retention unit 220, a communication unit 230, a cell ID acquisition unit 231, and a second location information acquisition unit 232. In addition, the wireless communication device 200 includes a second location information retention unit 250, a correction information acquisition unit 260, a correction information retention unit 270, a determination unit 280, and a determined location information recording unit 290.

The first location information acquisition unit 210 periodically or aperiodically acquires location information (longitude and latitude) based on a GPS signal transmitted from a GPS satellite. The first location information acquisition unit 210 generates location information, for example, by receiving GPS signals from a plurality of GPS satellites and calculating a distance from a location of each GPS satellite. The first location information acquisition unit 210 provides the first location information retention unit 220 and the determination unit 280 with the generated location information (first location information) along with a time when the location information was generated (a time when the location was acquired). In the same drawing, the location information provided from the first location information acquisition unit 210 is referred to as current first location information. In addition, the first location information acquisition unit 210 is an example of a first acquisition unit described in the claims.

The first location information retention unit 220 retains the first location information provided from the first location information acquisition unit 210 in association with the time (acquisition time) provided along with the first location information. When the determination unit 280 determines the location information from the second location information acquisition unit 232, the first location information retention unit 220 provides the determination unit 280 with the retained location information (first location information) along with the acquisition time. In the first embodiment of the present technology, when the determination unit 280 determines the location information, latest location information among pieces of location information previously acquired by the first location information acquisition unit 210 is provided to the determination unit 280. In the same drawing, the location information provided from the first location information retention unit 220 is referred to as previous first location information.

The communication unit 230 performs communication according to electric-wave transmission/reception. The communication unit 230 provides the cell ID acquisition unit 231 with a cell ID acquired from an electric wave provided from the base station 170. Specifically, the communication unit 230 acquires a cell ID, for example, contained in a broadcasting control channel transmitted from the base station, and provides the acquired cell ID to the cell ID acquisition unit 231. In addition, when the location information of the base station 170 has been received according to communication with the base station 170, the location information is provided to the second location information acquisition unit 232. In addition, if the wireless communication device 200 is connected to the server 180, the communication unit 230 transmits information (a cell ID and the like) necessary for the connection to the base station 170 through an electric wave.

The cell ID acquisition unit 231 acquires identification information (for example, the cell ID) unique to the base station reported from the base station 170. In the first embodiment of the present technology, the cell ID acquisition unit 231 acquires the cell ID at the timing when location information of the wireless communication device 200 is acquired in a state in which the location information is not acquired by at least the first location information acquisition unit 210. The cell ID acquisition unit 231 provides the acquired cell ID to the second location information acquisition unit 232 and the correction information acquisition unit 260.

The second location information acquisition unit 232 periodically or aperiodically acquires location information of the base station indicated by the cell ID provided from the cell ID acquisition unit 231. In the first embodiment of the present technology, in a state in which the first location information acquisition unit 210 does not acquire the location information, the second location information acquisition unit 232 acquires the location information at the timing when the location information of the wireless communication device 200 is acquired. If the cell ID has been provided from the cell ID acquisition unit 231, the second location information acquisition unit 232 generates a connection request for acquiring the location information of the base station indicated by the cell ID from the server 180, and provides the generated connection request to the communication unit 230. If the server 180 sending a response transmits the location information, the location information is provided from the communication unit 230 receiving communication to the second location information acquisition unit 232, and the second location information acquisition unit 232 acquires the location information of the base station. The second location information acquisition unit 232 provides the second location information retention unit 250 and the determination unit 280 with the acquired location information (second location information) along with a time when the location information was acquired. In the same drawing, the location information provided from the second location information acquisition unit 232 is referred to as current second location information. In addition, the second location information acquisition unit 232 is an example of a second acquisition unit described in the claims.

The second location information retention unit 250 retains the second location information provided from the second location information acquisition unit 232 in association with the acquisition time provided along with the second location information. When the determination unit 280 determines the location information from the second location information acquisition unit 232, the second location information retention unit 250 provides the determination unit 280 with the retained location information (second location information) along with the acquisition time of the location information. In the first embodiment of the present technology, when the determination unit 280 determines the location information, latest location information among pieces of location information previously acquired by the second location information acquisition unit 232 is provided to the determination unit 280. In addition, when correction information (see the description of the correction information acquisition unit 260) from the correction information acquisition unit 260 has been provided, the second location information retention unit 250 corrects the corresponding second location information with the correction information. In the same drawing, the location information provided from the second location information retention unit 250 is referred to as previous second location information.

The determination unit 280 determines a location (current location) of the wireless communication device 200 at a current time on the basis of the first location information and the second location information. If the current first location information is provided from the first location information acquisition unit 210, the determination unit 280 determines the current first location information as the current location, and causes the determined location information recording unit 290 to record the current location.

In addition, if no current first location information is provided from the first location information acquisition unit 210 (if no GPS signal can be received), the determination unit 280 determines the current location based on the current second location information provided from the second location information acquisition unit 232. First, the determination unit 280 determines whether or not the current second location information provided from the second location information acquisition unit 232 indicates a valid location as the current location of the wireless communication device 200 (or is wrong). In this case, the determination unit 280 determines latest location information (location information acquired at a time closest to the current time) among pieces of the previous first location information provided from the first location information retention unit 220 and the previous second location information provided from the second location information retention unit 250. The determination unit 280 calculates a distance between the determined latest previous location information and the current second location information, and analyzes whether or not the calculated distance exceeds a threshold value (compares locations).

If the distance is analyzed to be less than or equal to the threshold value, the current second location information is determined not to be wrong, and the current second location information is recorded on the determined location information recording unit 290 as the current location. On the other hand, if the distance is analyzed to exceed the threshold value, the current second location information is determined to be wrong (the association of the location information with the cell ID in the server 180 is determined to be wrong), and the correction information acquisition unit 260 is caused to acquire location information for correction (correction information). The correction information provided from the correction information acquisition unit 260 is recorded on the determined location information recording unit 290 as the current location. The determination unit 280 is an example of a detection unit and a determination unit described in the claims.

Here, the threshold value used to determine whether the current second location information is right or wrong will be described. The threshold value is used to determine whether or not the association of the location information with the cell ID in the server 180 is wrong. That is, it is preferable that the threshold value be available to determine whether a location indicated by the current second location information is too far from the latest previous location information (for example, when location information of Osaka is received while underground in Shibuya Station). Basically, the threshold value may be significantly large.

For example, a highest limit value of a distance assumed to be movable within a period of time from the acquisition time of the latest previous location information to the acquisition time of the current second location information is set to the threshold value. For example, the case of a longest distance in a situation in which no GPS signal is acquired in urban areas may be a subway ride. The determination unit 280 calculates the threshold value from a speed (for example, 150 km per hour) sufficiently higher than an actual maximum speed of the subway and a period of time from the acquisition time of the latest previous location information to the acquisition time of the current second location information. For example, when the period of time from the acquisition time of the latest previous location information to the acquisition time of the current second location information is “10 minutes,” a value of “25 km” is set as the threshold value.

When a correction information acquisition command has been provided from the determination unit 280, the correction information acquisition unit 260 acquires correction information from the correction information retention unit 270 on the basis of a cell ID provided from the cell ID acquisition unit 231. That is, when the current second location information is determined to be wrong, the correction information acquisition unit 260 acquires the correction information from the correction information retention unit 270 on the basis of the cell ID associated with the current second location information. The correction information acquisition unit 260 provides the acquired correction information (location information) to the determination unit 280 and the second location information retention unit 250.

The correction information retention unit 270 retains a DB (correction DB) in which location information (correction information) for correction is associated with cell IDs. The correction information retention unit 270 is retained by a recording device (for example, a flash memory) provided in the wireless communication device 200. The correction DB is generated, for example, by detecting a cell ID for which location information is wrong in the DB of the server 180 and associating right location information with the cell ID. The correction DB is separated from the DB of the server 180, and, for example, is provided from a provider of a service using the location information. That is, the correction DB is used to prevent the service provider (for the service using the location information), which is separate from an operating company of the server 180, from providing service based on wrong location information. The correction DB can be constructed, for example, by requesting each wireless communication device (each mobile terminal) to report a current cell ID and information regarding a current location acquired by GPS and collecting reported information.

The determined location information recording unit 290 retains location information (current location information) determined by the determination unit 280 to be a current location. An application acquires latest location information retained in the determined location information recording unit 290, so that various services are provided using a location where a user is currently located.

[Examples of DB of Server and Correction DB of Correction Information Retention Unit]

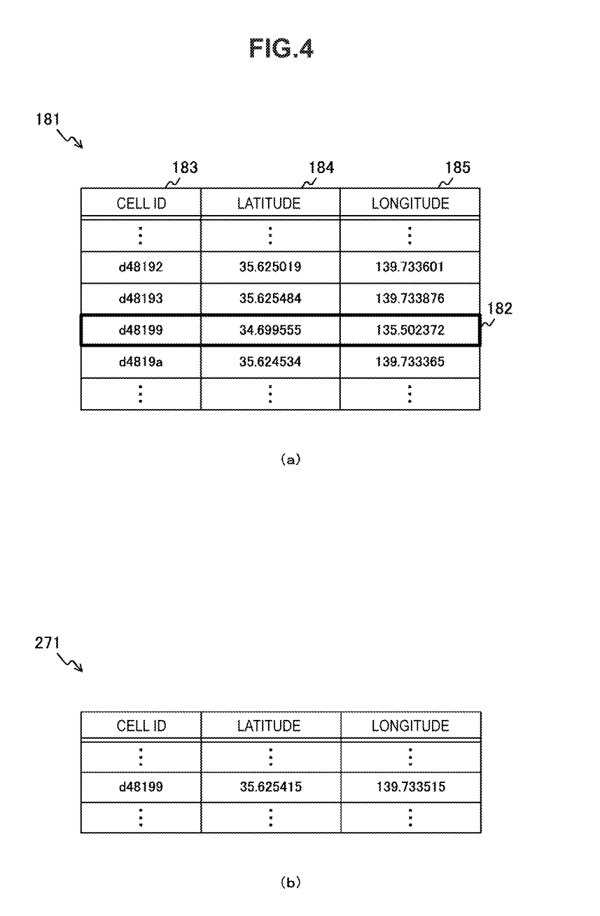

FIG. 4 is a simplified diagram illustrating examples of the DB retained in the server 180 and the correction DB retained in the correction information retention unit 270 according to the first embodiment of the present technology.

A table (table 181) obtained by simplifying the DB retained in the server 180 is illustrated in FIG. 4(a). In the DB retained in the server 180, a cell ID indicating a base station of a location management target is associated with a location (latitude and longitude) of the base station indicated by the cell ID. In the table 181, latitude (a cell of a column 184) and longitude (a cell of a column 185) associated with a cell ID are shown in the same row as that of a cell (a cell of a column 183) to which the cell ID is written.

Location information of a cell ID (d48199) surrounded by a frame 182 among four cell IDs shown in the table 181 is assumed to be wrong, and the correction DB retained in the correction information retention unit 270 will be described with reference to FIG. 4(b).

In FIG. 4(b), a table (table 271) in which the correction DB retained in the correction information retention unit 270 is simplified is illustrated. In the correction DB retained in the correction information retention unit 270, right location information is associated with the cell ID of which location information is wrong in the DB (table 181) retained in the server 180. In this correction DB, a cell ID associated with the right location information in the DB of the server 180 is not stored. That is, right location information (latitude “35.625415” and longitude “139.733515”) of a base station of the cell ID “d48199” surrounded by the frame 182 among the four cell IDs illustrated in FIG. 4(a) is stored in association with the cell ID “d48199.”

The wireless communication device 200 retains the correction DB as illustrated in FIG. 4(b), thereby appropriately determining the current location even when the location information of the base station acquired by the wireless communication device 200 is wrong. That is, it is possible to appropriately determine a current location even when wrong location information is provided from the server 180 as location information of a base station with which communication is in progress when no GPS signal can be received.

[Operation Example of Wireless Communication Device]

Next, the operation of the wireless communication device 200 according to the first embodiment of the present technology will be described with reference to the drawings.

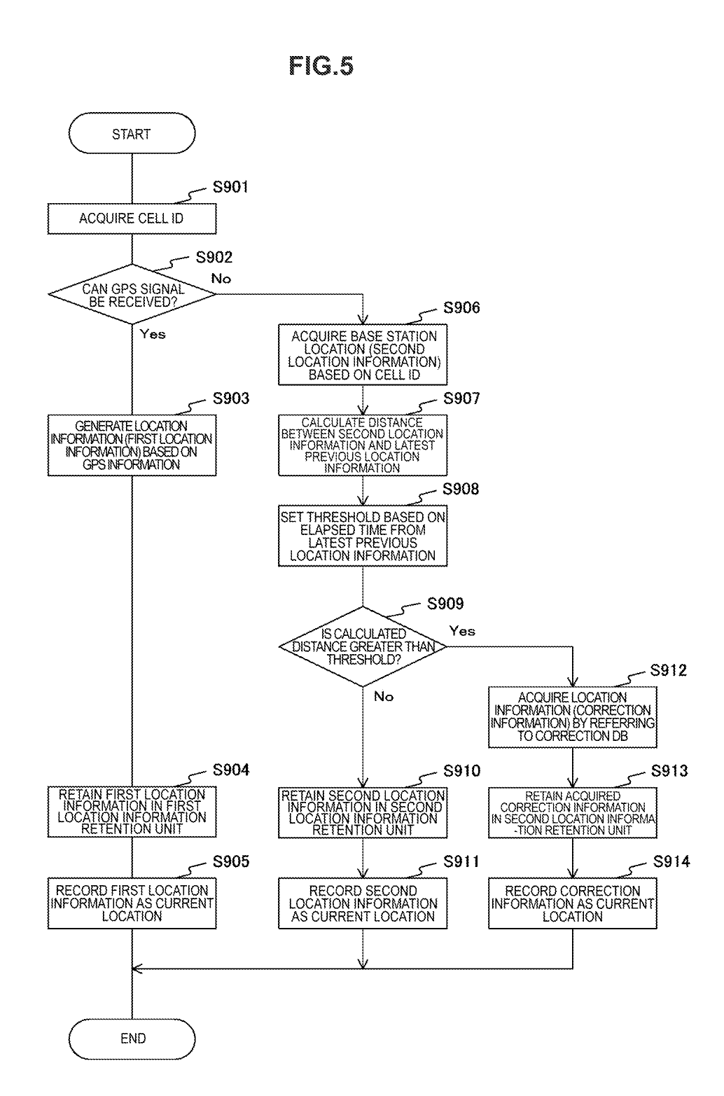

FIG. 5 is a flowchart illustrating an example of a current location determination processing procedure when the wireless communication device 200 determines a current location according to the first embodiment of the present technology. In FIG. 5, one operation in which the current location is determined is illustrated.

First, an identification number (cell ID) of a base station with which communication is currently in progress is acquired by the cell ID acquisition unit 231 (step S901). In addition, the first location information acquisition unit 210 determines whether or not a GPS signal can be received from a GPS satellite (step S902). If the GPS signal is determined to be able to be received (step S902), location information (first location information) is generated on the basis of the received GPS signal (step S903).

Thereafter, the generated first location information is retained in the first location information retention unit 220 (step S904). In addition, the generated first location information is determined by the determination unit 280 to be a current location and recorded on the determined location information recording unit 290 (step S905). The operation of the current location determination process ends.

On the other hand, if no GPS signal is determined to be able to be received (step S902), the second location information acquisition unit 232 acquires location information of a base station indicated by the cell ID on the basis of the acquired cell ID (step S906). Thereafter, the determination unit 280 calculates a distance between a location indicated by latest location information (latest previous location information) among pieces of previous location information retained in the first location information retention unit 220 and the second location information retention unit 250 and a location indicated by the second location information (step S907).

Subsequently, the determination unit 280 sets a threshold value on the basis of a period of time (elapsed time) between a time when the second location information was acquired and a time when the latest previous location information was acquired (step S908). Thereafter, the determination unit 280 determines whether or not the calculated distance is greater than the threshold value (step S909). If the calculated distance is determined not to be greater than the threshold value (or is determined to be less than or equal to the threshold value) (step S909), the second location information is retained in the second location information retention unit 250 (step S910). In addition, the second location information is determined by the determination unit 280 to be the current location and recorded on the determined location information recording unit 290 (step S911). The operation of the current location determination process ends.

If the calculated distance is determined to be greater than the threshold value (step S909), correction information (right location information) corresponding to the cell ID is acquired by the correction information acquisition unit 260 from the correction DB in the correction information retention unit 270 (step S912). The acquired correction information is retained in the second location information retention unit 250 (step S913). In addition, the correction information is determined by the determination unit 280 to be the current location, and recorded on the determined location information recording unit 290 (step S914). The operation of the current location determination process ends. Step S909 is an example of detecting described in the claims. In addition, step S914 is an example of determining described in the claims.

According to the first embodiment of the present technology as described above, the wireless communication device can appropriately determine a current location even when wrong location information is supplied from the server as a location of a base station.

### 4. Second Embodiment

In the first embodiment of the present technology, description has been given under the assumption that a perfect correction DB can be prepared in the correction information retention unit 270. However, because it is difficult to prepare the perfect correction DB in a situation in which a base station is frequently expanded and updated, it is desirable for the wireless communication device 200 to update the correction DB.

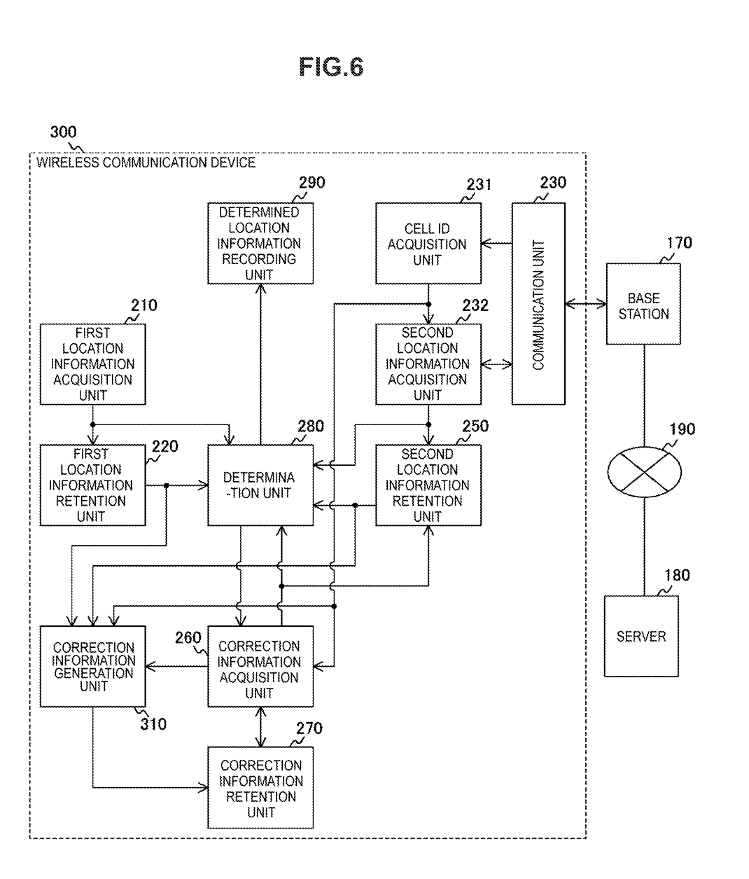

In the second embodiment of the present technology, an example of the wireless communication device 200 that generates correction information when there is no right location information (correction information) of the base station in the correction DB will be described with reference to FIGS. 6 to 8.

[Configuration Example of Wireless Communication Device]

FIG. 6 is a block diagram illustrating a configuration example of a wireless communication device 300 according to the second embodiment of the present technology.

The wireless communication device 300 includes a correction information generation unit 310 in addition to the elements of the wireless communication device 200 illustrated in FIG. 3. Elements other than the correction information generation unit 310 are denoted by the same reference numerals as those of FIG. 3, and therefore description thereof is omitted here. In FIG. 3, the configuration of the wireless communication device 300 will be described, focusing on the correction information generation unit 310.

The correction information generation unit 310 generates correction information when there is no correction information necessary for the correction DB of the correction information retention unit 270. A cell ID from the cell ID acquisition unit 231, previous first location information from the first location information retention unit 220, and previous second location information from the second location information retention unit 250 are provided to the correction information generation unit 310.

In addition, when the correction information acquisition unit 260 has not acquired the correction information (when there is no correction information in the correction DB), a command for causing the correction information to be generated is provided from the correction information acquisition unit 260 to the correction information generation unit 310. This command is provided if it is detected that there is no correction information for a cell ID provided from the cell ID acquisition unit 231 in the correction information retention unit 270 when the correction information acquisition unit 260 acquires the correction information.

When the correction information generation command has been provided from the correction information acquisition unit 260, the correction information generation unit 310 determines latest location information among the previous first location information and the previous second location information as the correction information for the cell ID (generates the correction information). The correction information generation unit 310 associates the generated correction information with the cell ID, provides an association result to the correction information retention unit 270, and updates the correction DB. The correction information acquisition unit 260 acquires the generated correction information from the correction DB, and provides the correction information to the determination unit 280 and the second location information retention unit 250. The correction information generation unit 310 is an example of a generation unit described in the claims.

[Configuration Example of Wireless Communication Device]

Next, an operation of the wireless communication device 300 according to the second embodiment of the present technology will be described with reference to the drawings.

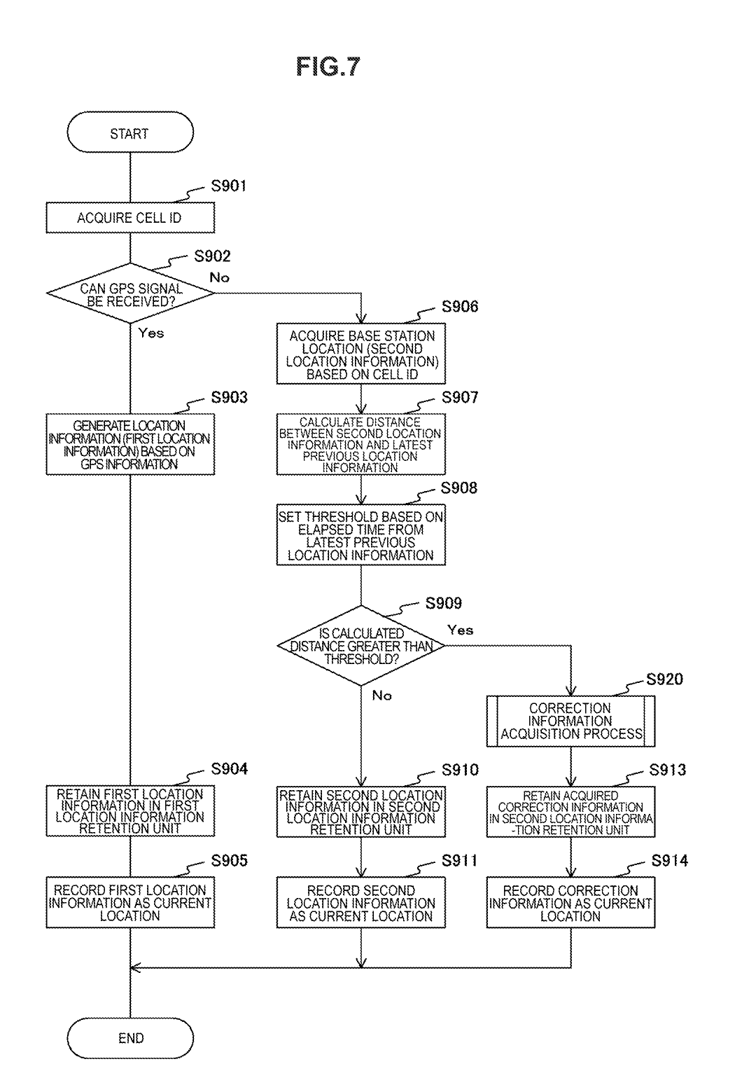

FIG. 7 is a flowchart illustrating an example of a current location determination processing procedure in which the wireless communication device 300 determines a current location according to the second embodiment of the present technology.

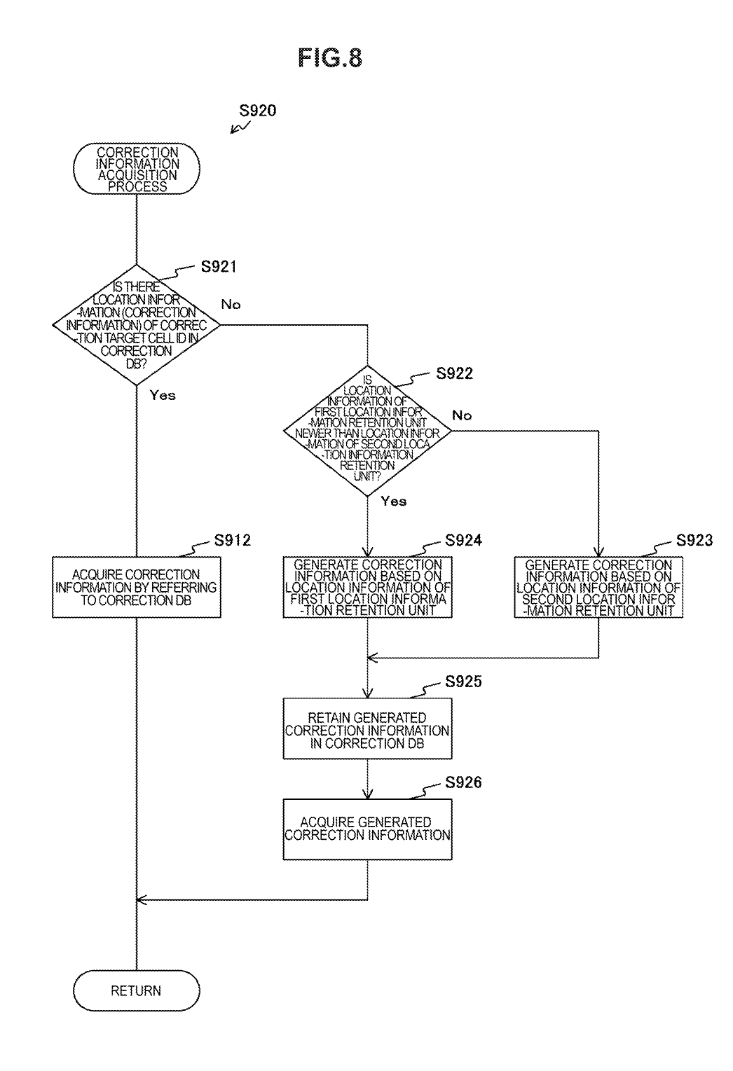

The current location determination processing procedure illustrated in FIG. 7 is a modified example of the current location determination processing procedure illustrated in FIG. 5, and is different from that of FIG. 5 only in that a correction information generation operation is added to the procedure (step S912) of acquiring the correction information of FIG. 5. In FIG. 7, the procedure of acquiring the correction information is illustrated as the correction information acquisition process (step S920). Other procedures are denoted by the same reference numerals as in FIG. 5 and description thereof is omitted. The correction information acquisition process (step S920) will be described with reference to FIG. 8.

FIG. 8 is a flowchart illustrating an example of a processing procedure of the correction information acquisition process (step S920) in the current location determination processing procedure of the second embodiment of the present technology.

First, the correction information acquisition unit 260 determines whether or not there is correction information (right location information) corresponding to a cell ID of a base station of a correction target of location information in the correction DB of the correction information retention unit 270 (step S921). If the correction information corresponding to the cell ID is determined to be present (step S921), the correction information is acquired from the correction DB (step S912) and the correction information acquisition processing procedure ends.

On the other hand, if the correction information corresponding to the cell ID is determined to be absent (step S921), it is determined whether the correction information is designated as the location information from the first location information retention unit 220 or the location information from the second location information retention unit 250 (step S922). Thereby, the correction information generation unit 310 determines whether or not the latest previous first location information provided from the first location information retention unit 220 is newer than the latest previous second location information provided from the second location information retention unit 250.

If the previous first location information is determined not to be newer than the previous second location information (step S922), the provided previous second location information is determined to be the correction information (the correction information is generated) (step S923), and the procedure proceeds to step S925.

In addition, if the previous first location information is determined to be newer than the previous second location information (step S922), the provided previous first location information is determined to be the correction information (the correction information is generated) (step S924). Subsequently, the generated correction information is retained (registered) in the correction DB of the correction information retention unit 270 along with the cell ID provided from the cell ID acquisition unit 231 (step S925). In addition, the generated correction information is acquired by the correction information acquisition unit 260 (step S926) and the correction information acquisition processing procedure ends.

According to the second embodiment of the present technology as described above, the wireless communication device can determine an appropriate current location by generating correction information when there is no correction information in the correction DB.

### 5. Third Embodiment

In the second embodiment of the present technology, an example in which correction information is generated by associating latest location information of previous first location information and previous second location information with a cell ID has been described. In this example, if location information based on a cell ID of a base station is acquired to generate correction information after a determination of a current location using a cell ID is continued, the location information of a base station (separate base station) serving as a last current location becomes a location of a base station of a correction information generation target.

A distance between base stations is several hundreds of meters to several kilometers. Thus, the accuracy of correction information (whether or not the correction information is close to an actual location of a base station) may be good when the correction information is generated using previous first location information (GPS-based location information) older than previous second location information according to a moving distance of the user.

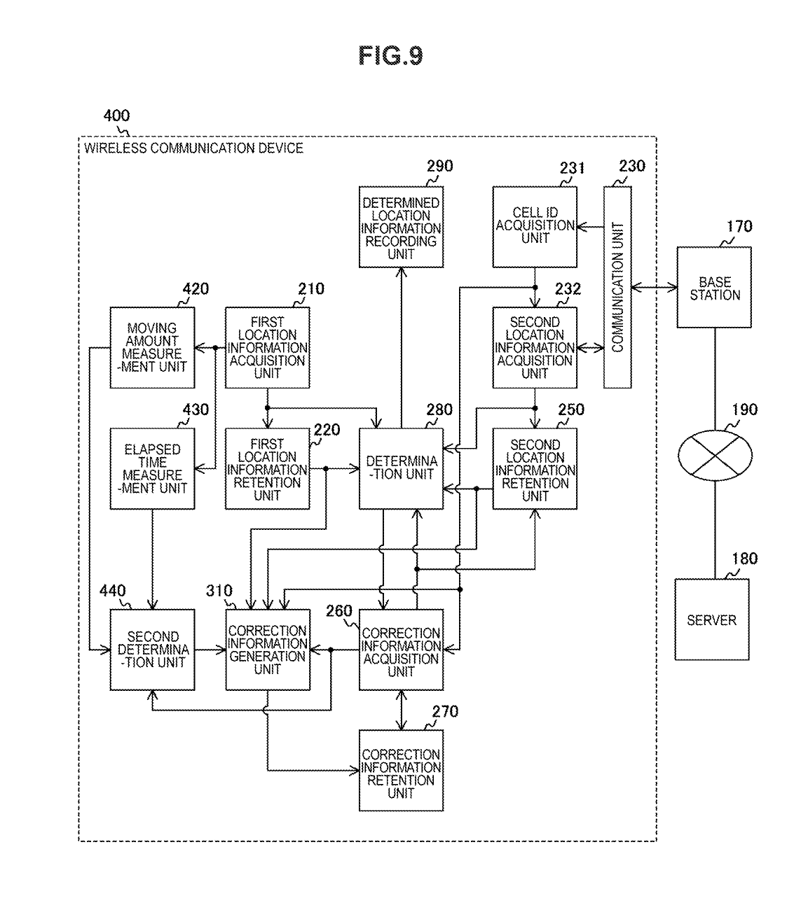

In the third embodiment of the present technology, an example in which a moving amount is detected from a location indicated by first location information previously acquired when correction information is generated, and the correction information is generated on the basis of the moving amount will be described with reference to FIGS. 9 to 11.

[Configuration Example of Wireless Communication Device]

FIG. 9 is a block diagram illustrating a configuration example of a wireless communication device 400 according to the third embodiment of the present technology.

In addition to the elements of the wireless communication device 300 illustrated in FIG. 6, the wireless communication device 400 includes a moving amount measuring unit 420, an elapsed time measuring unit 430, and a second determination unit 440. Because elements other than the above-described elements are the same as those of FIG. 6, the same elements are denoted by the same reference numerals and description thereof is omitted here. In FIG. 9, the configuration of the wireless communication device 400 will be described, focusing on the moving amount measuring unit 420, the elapsed time measuring unit 430, and the second determination unit 440.

The moving amount measurement unit 420 calculates a moving amount of the wireless communication device 400 from a location where location information is generated by the first location information acquisition unit 210 from a GPS signal. The moving amount measurement unit 420 is implemented, for example, by detecting acceleration from the acceleration detected by an acceleration sensor and detecting a moving direction by a direction sensor or a gyro sensor. The moving amount measurement unit 420 starts measurement at the timing when the first location information acquisition unit 210 generates location information from a GPS signal. That is, the moving amount measurement unit 420 provides a moving amount from the generation timing of the latest previous first location information. The moving amount measurement unit 420 provides the measured moving amount (acceleration and moving direction) to the second determination unit 440.

The elapsed time measurement unit 430 measures an elapsed time from when the first location information acquisition unit 210 generates the location information from a GPS signal. The elapsed time measurement unit 430 is implemented, for example, by a counter circuit or a clock function mounted on the wireless communication device 400. The elapsed time measurement unit 430 starts measurement at the timing when the first location information acquisition unit 210 generates the location information from the GPS signal. That is, the elapsed time measurement unit 430 provides the elapsed time from the generation timing of the latest previous first location information. The elapsed time measurement unit 430 provides the measured elapsed time to the second determination unit 440.

The second determination unit 440 determines which of previous first location information and previous second location information is determined to be correction information on the basis of the moving amount provided from the moving amount measurement unit 420 and the elapsed time provided from the elapsed time measurement unit 430. The second determination unit 440 determines whether to generate the correction information if a correction information generation command has been provided from the correction information acquisition unit 260, which has not acquired the correction information from the correction information retention unit 270.

When the correction information generation command has been provided from the correction information acquisition unit 260, the second determination unit 440 calculates a moving distance of the wireless communication device 400 at the elapsed time on the basis of the moving amount provided from the moving amount measurement unit 420 and the elapsed time provided from the elapsed time measurement unit 430. The second determination unit 440 compares the moving distance provided from the moving amount measurement unit 420 to the threshold value. If the moving distance is greater than the threshold value, the second determination unit 440 determines to associate the previous second location information with a cell ID of a base station of a correction target and provides its determination result to the correction information generation unit 310. In addition, if the moving distance is less than or equal to the threshold value, the second determination unit 440 determines to associate the previous first location information with the cell ID of the base station of the correction target and provides its determination result to the correction information generation unit 310. The second determination unit 440 and the correction information generation unit 310 are an example of a generation unit described in the claims.

The correction information generation unit 310 associates either latest previous first location information or latest previous second location information with the cell ID of the base station on the basis of the determination result provided from the second determination unit 440, and determines an association result as correction information.

Here, the threshold value in the section determination unit 440 will be described. The threshold value is used to determine which of previous first location information or previous second location information is designated as correction information in a correction information determination (generation). In terms of a location of the base station indicated by the previous second location information, because a radio signal from the base station can be received in a range of several hundreds of meters to several kilometers (a maximum distance is different according to a size of the base station), the accuracy of acquisition of location information according to a cell ID also becomes several hundreds of meters to several kilometers. As the threshold value, a value in which it is preferable to use previous second location information is used because a moving distance is too long if previous first location information is used (because the previous second location information is more likely to be close to an actual location of a base station). Although the threshold value also differs according to a communication scheme, the previous second location information is determined to be correction information, for example, when a value of “500 m” is set as the threshold value and the moving distance is greater than this threshold value.

[Operation Example of Wireless Communication Device]

Next, the operation of the wireless communication device 400 according to the third embodiment of the present technology will be described with reference to the drawings.

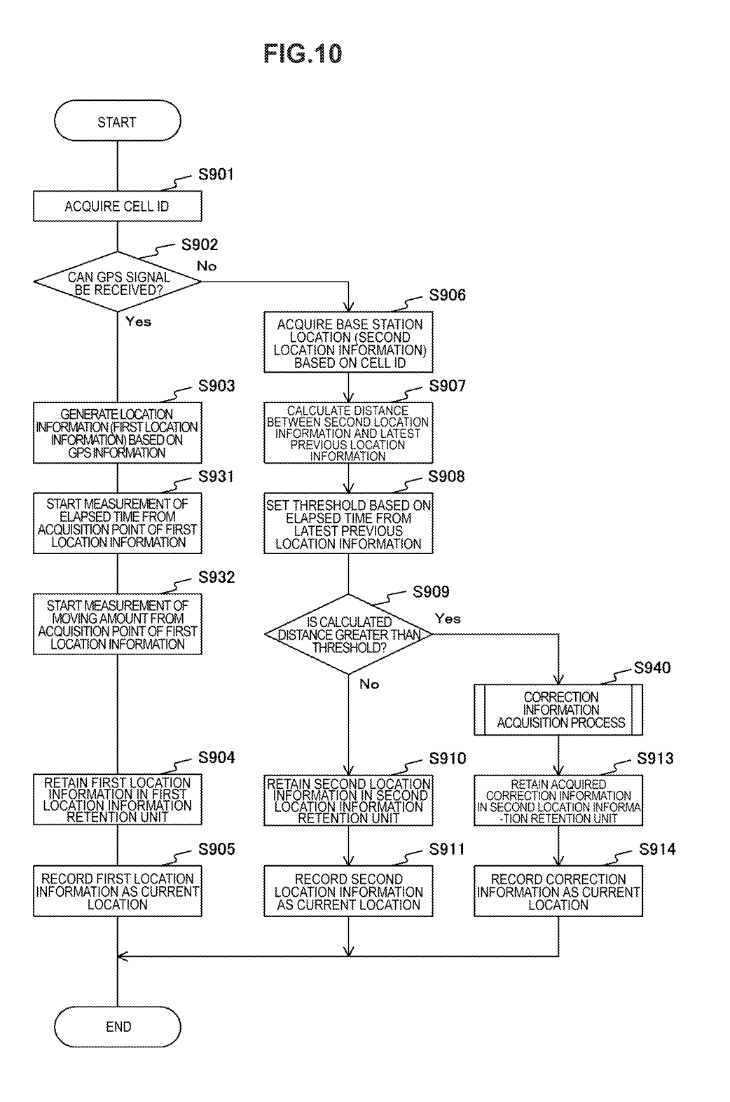

FIG. 10 is a flowchart illustrating an example of a current location determination processing procedure in which the wireless communication device 400 determines a current location according to the third embodiment of the present technology.

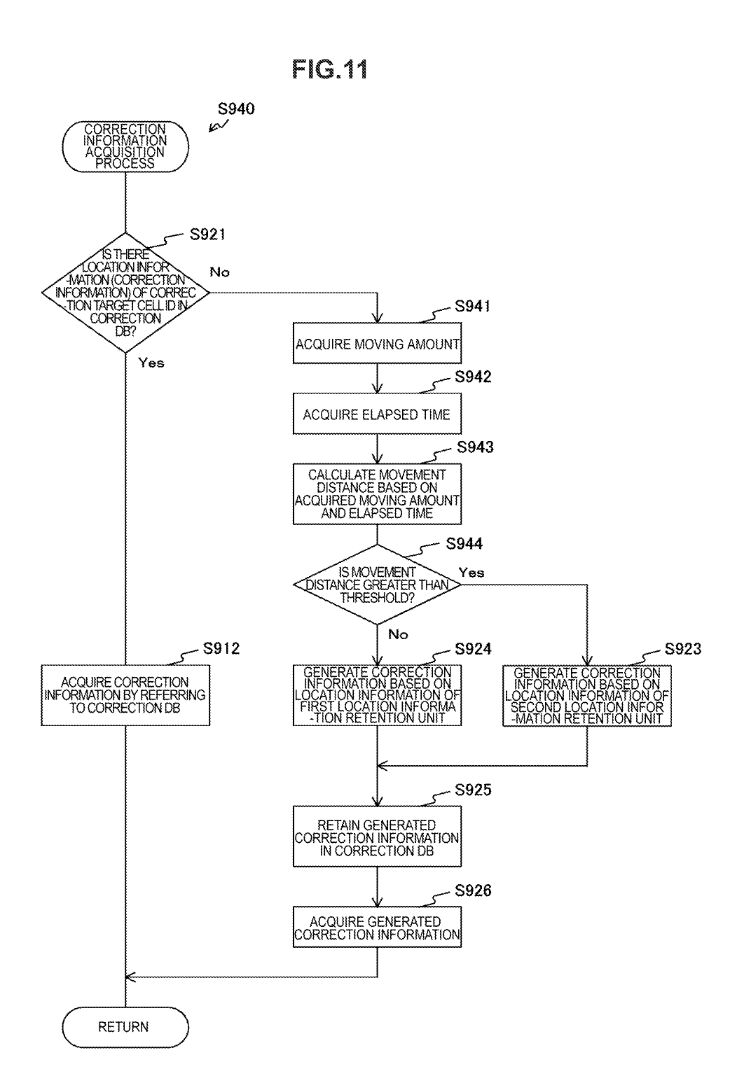

The current location determination processing procedure illustrated in FIG. 10 is a modified example of the current location determination processing procedure illustrated in FIG. 7, and is different from that of FIG. 7 only in that operations of generating a moving distance and an elapsed time are added as content of an acquisition procedure in the correction information acquisition process. The same procedures as those illustrated in FIG. 7 are denoted by the same reference numerals in FIG. 10, and description thereof is omitted here. The correction information acquisition process (step S940) corresponding to the correction information acquisition process (step S920) of FIG. 7 will be described with reference to FIG. 11.

After the first location information acquisition unit 210 has generated location information (first location information) on the basis of a received GPS signal (step S903), the elapsed time measurement unit 430 starts the measurement of an elapsed time from this timing (step S931). In addition, the moving amount measurement unit 420 starts the measurement of a moving amount (acceleration and moving direction) from a location where the first location information has been generated (step S932) and the procedure proceeds to step S904.

Any of steps S931 and S932 may be first performed.

FIG. 11 is a flowchart illustrating an example of a processing procedure of the correction information acquisition process (step S940) in the current location determination processing procedure of the third embodiment of the present technology.

The correction information acquisition process (step S940) is a modified example of the correction information acquisition process (step S920) illustrated in FIG. 8, and is different from the correction information acquisition process (step S920) of FIG. 8 in that a determination is made to switch location information serving as correction information on the basis of the moving amount and the elapsed time. The same procedures are denoted by the same reference numerals and description thereof is omitted here.

After correction information corresponding to a cell ID is determined to be absent (step S921), the second determination unit 440 acquires the moving amount measured by the moving amount measurement unit 420 (step S941). In addition, the elapsed time measured by the elapsed time measurement unit 430 is acquired by the second determination unit 440 (step S942). Any of steps S941 and S942 may be first performed.

Subsequently, the second determination unit 440 calculates a moving distance of the wireless communication device on the basis of the acquired moving amount and elapsed time (step S943). Next, the second determination unit 440 determines whether the calculated moving distance is greater than the threshold value (step S944).

If the moving distance is determined to be greater than the threshold value (step S944), the procedure proceeds to step S923.

On the other hand, if the moving distance is determined not to be greater than the threshold value (step S944), the procedure proceeds to step S924.

According to the third embodiment of the present technology as described above, if there is no correction information in the correction DB, previous first location information is designated as correction information, regardless of the elapsed time, according to a moving distance from a point where the previous first location information was acquired, and has priority over previous second location information, so that it is possible to improve the accuracy of determination of a current location.

### 6. Fourth Embodiment

In the first to third embodiments of the present technology, an example in which the correction DB is retained inside the wireless communication device has been described. However, the present technology is not limited thereto, and the correction DB may be provided in the server.

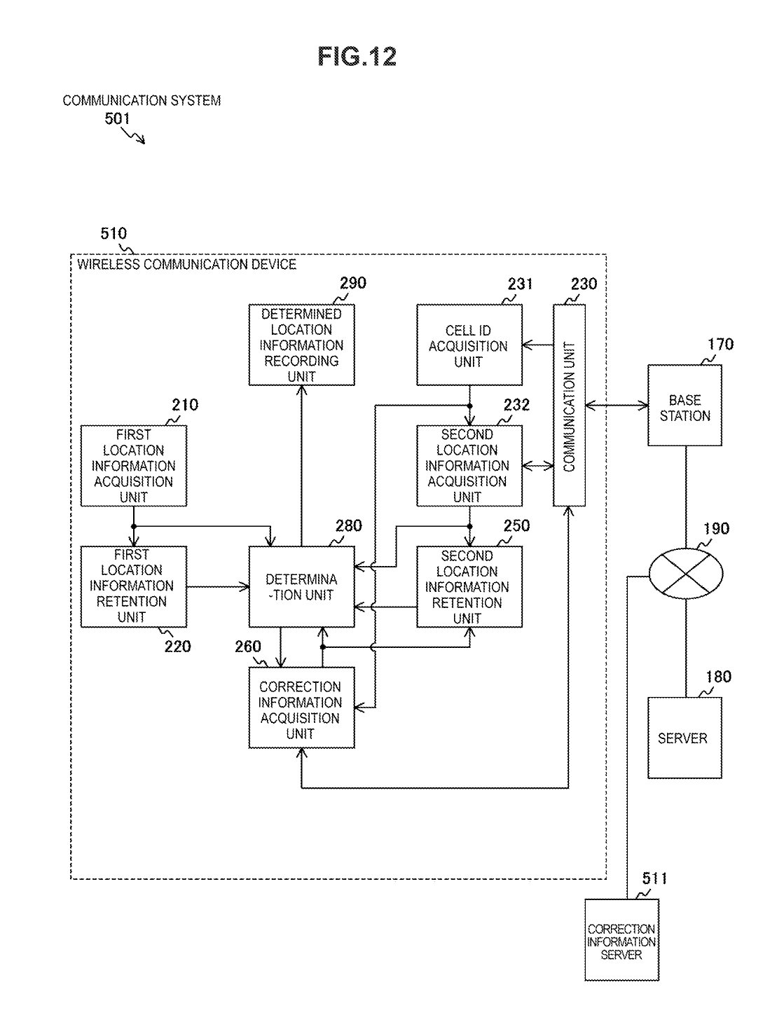

An example in which the correction DB for the wireless communication device of the first to third embodiments of the present technology is provided in the server will be described with reference to FIGS. 12 to 14.

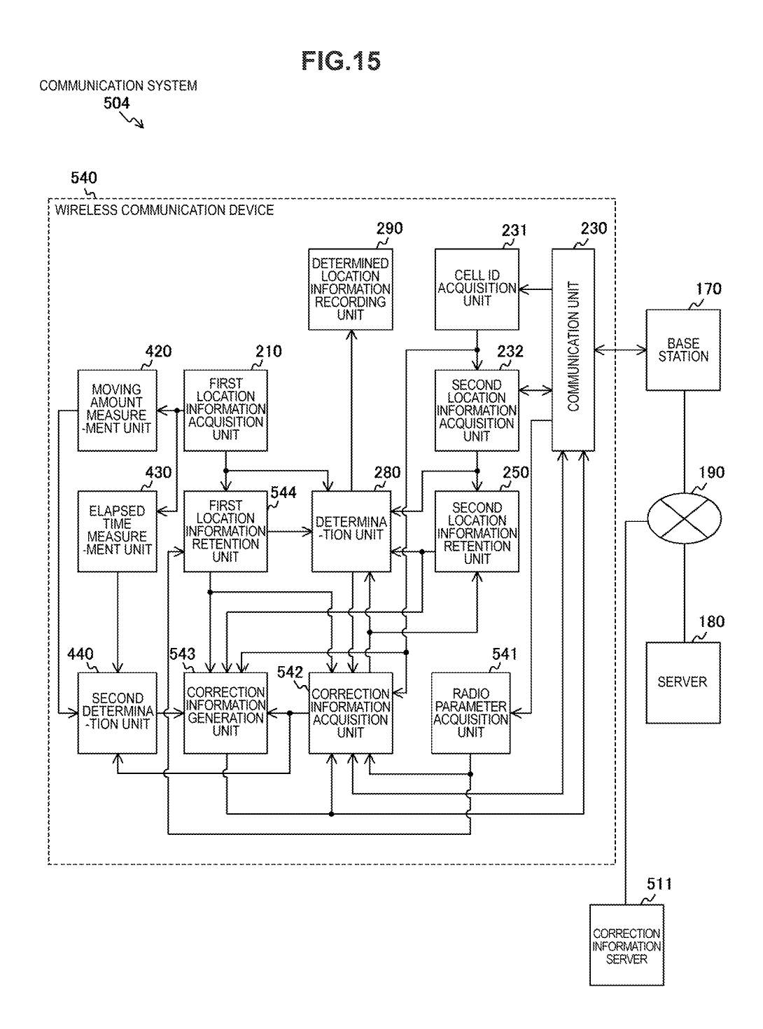

In addition, if the correction DB is provided in the server, a plurality of users can update correction information. Thereby, it is possible to improve the accuracy of correction information. An example in which the correction DB is updated according to correction information generated by a wireless communication device closer to a base station will be described with reference to FIG. 15.

[Configuration Example of Wireless Communication Device]

FIG. 12 is a block diagram illustrating a configuration example of a communication system 501 including a wireless communication device 510 corresponding to the wireless communication device 200 of the first embodiment of the present technology according to a fourth embodiment of the present technology.

The communication system 501 has the wireless communication device 510, a base station 170, a server 180, a public network 190, and a correction information server 511. The wireless communication device 510 is a modified example of the wireless communication device 200 of the first embodiment, and is not provided with the correction information retention unit 270. Instead, the correction information server 511 having the correction DB is provided in the communication system 501. Because elements of the wireless communication device 510 are the same as those of the wireless communication device 200 of FIG. 3, the same elements are denoted by the same reference numerals and description thereof is omitted. Because the base station 170, the server 180, and the public network 190 are also the same as those of FIG. 3, these are denoted by the same reference numerals and description thereof is omitted here. Here, a description will be given, focusing on the correction information server 511.

The correction information server 511 retains the correction DB. That is, the correction information server 511 functions as the correction information retention unit 270 illustrated in FIG. 3. The correction information server 511 is an example of an information processing device described in the claims.

In the wireless communication device 510, the correction information acquisition unit 260 provides the communication unit 230 with a communication execution command for acquiring correction information associated with a cell ID from the cell ID acquisition unit 231 when receiving a correction information acquisition command. When the communication unit 230 executes communication, the correction information server 511 provides the wireless communication device 510 with requested location information (correction information) associated with the cell ID in response to the communication. Thereby, the correction information acquisition unit 260 acquires the correction information.

As described above, the correction DB can be provided in the server (correction information server 511). Thereby, the wireless communication device 510 can constantly perform correction using the latest correction DB.

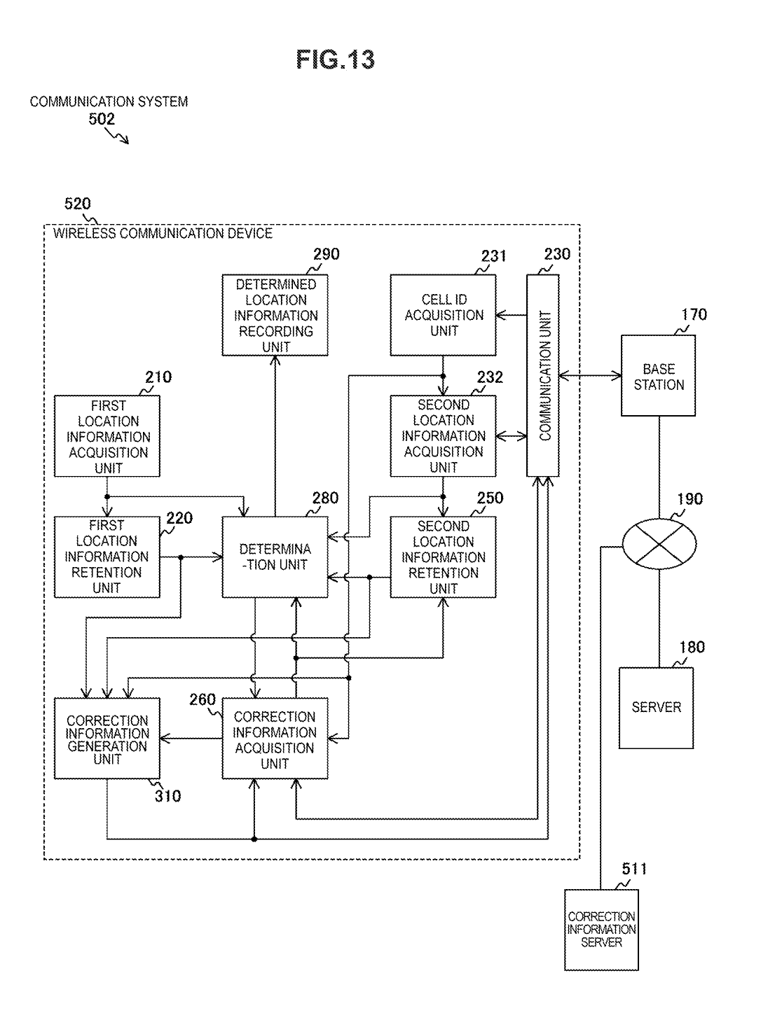

FIG. 13 is a block diagram illustrating a configuration example of a communication system 502 including a wireless communication device 520 corresponding to the wireless communication device 300 of the second embodiment of the present technology according to the fourth embodiment of the present technology.

The wireless communication device 520 of the communication system 502 is a modified example of the wireless communication device 300 of the second embodiment, and is different from the wireless communication device 300 only in that the correction information server 511 is provided instead of the correction information retention unit 270. That is, correction information is provided from the correction information server 511 as in the wireless communication device 510 illustrated in FIG. 12

In addition, when there is no necessary correction information in the correction DB, this is reported from the correction information server 511 to the correction information acquisition unit 260 via wireless communication. The correction information acquisition unit 260 receiving the report provides a correction information generation command to the correction information generation unit 310, so that the correction information generation unit 310 generates the correction information. Thereafter, the generated correction information is provided to the correction information acquisition unit 260 and also provided to the correction information server 511 according to wireless communication via the communication unit 230, so that the correction DB is updated.

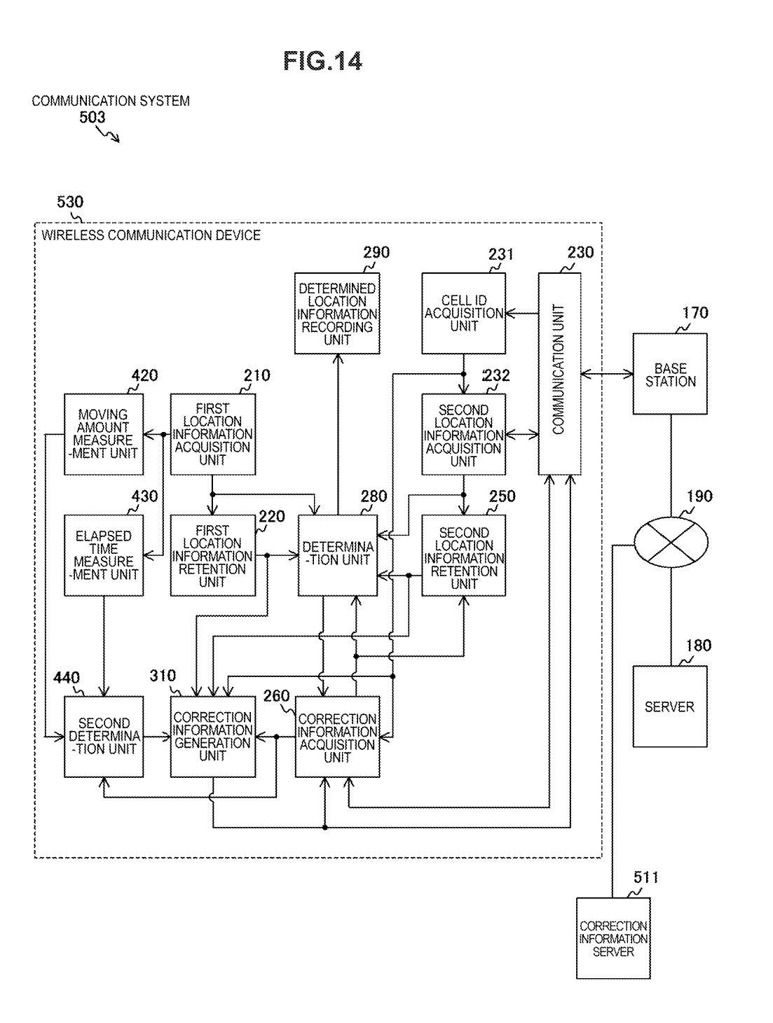

FIG. 14 is a block diagram illustrating a configuration example of a communication system 503 including a wireless communication device 530 corresponding to the wireless communication device 300 of the third embodiment of the present technology according to the fourth embodiment of the present technology.

The wireless communication device 530 of the communication system 503 is a modified example of the wireless communication device 300 of the third embodiment. As in the wireless communication devices 510 and 520 described with reference to FIGS. 12 and 13, the correction DB is used in the correction information server 511.

FIG. 15 is a block diagram illustrating a configuration example of a communication system 504 in which a correction DB is updated according to correction information generated by a wireless communication device closer to a base station in the fourth embodiment of the present technology.

In FIG. 15, the communication system 504 includes a wireless communication device 540, a base station 170, a server 180, a public network 190, and a correction information server 511.

The wireless communication device 540 is a modified example of the wireless communication device 530 illustrated in FIG. 14, and includes a first location information retention unit 544, a correction information acquisition unit 542, and a correction information generation unit 543 instead of the first location information retention unit 220, the correction information acquisition unit 260, and the correction information generation unit 310. In addition, the wireless communication device 540 further includes a radio parameter acquisition unit 541. Here, a description will be given, focusing on the radio parameter acquisition unit 541, the first location information retention unit 544, the correction information acquisition unit 542, and the correction information generation unit 543.

The radio parameter acquisition unit 541 acquires a parameter included in a radio signal provided from the base station 170. The parameter acquired by the radio parameter acquisition unit 541 is information regarding signal strength for analyzing whether or not the wireless communication device 540 is close to the base station 170. For example, if the wireless communication device 540 is a Third Generation Partnership Project (3GPP) standard, the radio parameter acquisition unit 541 acquires the strength of a pilot signal. The wireless communication device 540 can detect a pilot signal having a strength of −120 dBm to −25 dBm. The stronger the pilot signal is (close to −25 dBm), the more likely the wireless communication device 540 is to be close to the base station.

If the wireless communication device 540 is a terminal other than that of 3GPP (for example, a mobile phone other than that of a wireless local area network (LAN) or 3GPP), the radio parameter acquisition unit 541 acquires a received signal strength indicator (RSSI).

The radio parameter acquisition unit 541 provides the acquired parameter (reception level information) to the first location information retention unit 544 and the correction information acquisition unit 542.

Like the first location information retention unit 220 described so far, the first location information retention unit 544 retains previous first location information. In addition to the first location information from the first location information acquisition unit 210, the reception level information is provided from the radio parameter acquisition unit 541 to the first location information retention unit 544. When retaining the previous first location information, the first location information retention unit 544 further retains reception level information regarding a signal received by the communication unit 230 in association therewith at the timing when the first location information is acquired.

Like the first location information retention unit 220 described so far, the first location information retention unit 544 provides the retained location information (the first location information) along with an acquisition time when the location information is supplied to the determination unit 280. When the location information is provided to the correction information generation unit 543 and the correction information acquisition unit 542, the first location information retention unit 544 also provides the associated reception level information in addition to the first location information and the acquisition time.

The correction information acquisition unit 542 has a function of analyzing whether or not the location information (correction information) provided from the correction information server 511 indicates a location close to the base station 170 in addition to the function of the correction information acquisition unit 260 described so far. Here, the function of the correction information acquisition unit 542 using the reception level information will be described.

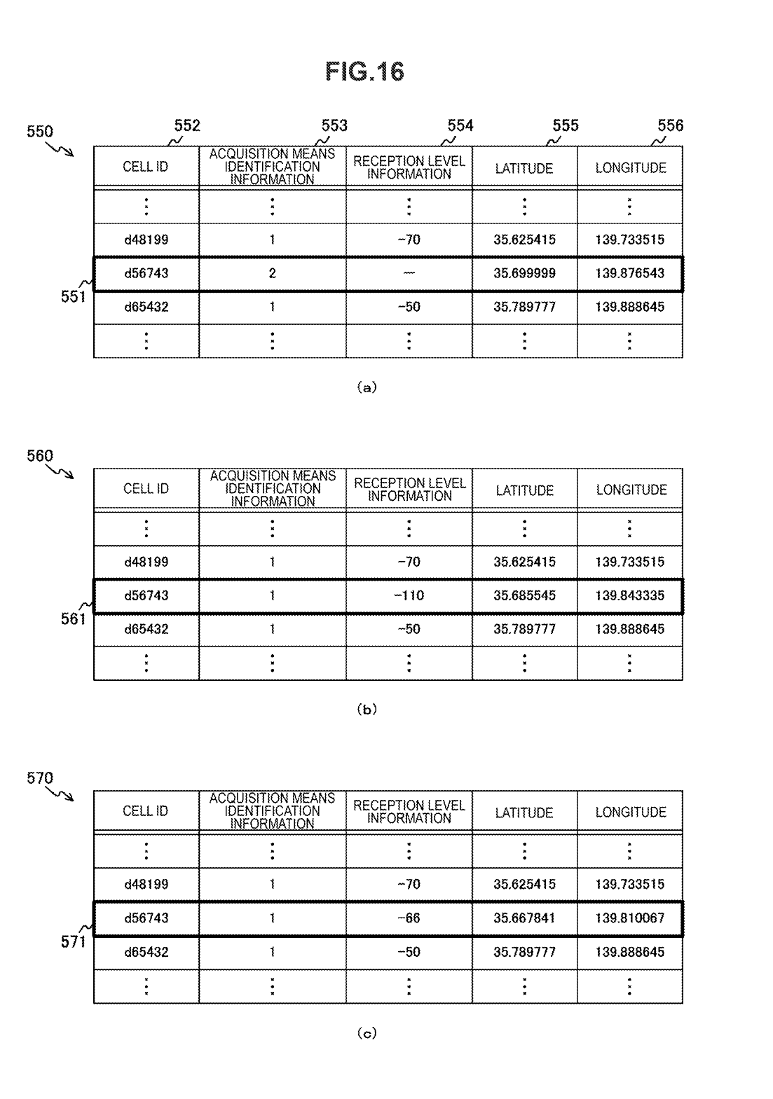

First, the correction information retained in the correction information server 511 according to the fourth embodiment of the present technology will be described. In the fourth embodiment of the present technology, the correction information server 511 associates information (acquisition means identification information), indicating whether the location information is derived from the first or second location information, other than the location information (correction information), as information associated with the cell ID. In addition, if the acquisition means identification information indicates the first location information, strength information (reception level information) of a received signal is also associated therewith when the first location information is generated. If correction information is provided in response to a request of the correction information from the wireless communication device 540, the correction information server 511 also transmits the acquisition means identification information and the reception level information therewith. Because the correction information retained in the correction information server 511 will be described with reference to FIG. 16, description thereof is omitted here. The acquisition means identification information is an example of attribute information described in the claims. In addition, the reception level information is an example of signal strength information described in the claims.

As described above, the correction information acquisition unit 542 receiving the acquisition means identification information and the reception level information along with the location information determines whether or not the provided correction information is updated to correction information with a higher accuracy (correction information closer to a location of an original base station) on the basis of previous first location information.

Here, a description will be provided, focusing on the correction information acquisition unit 542, the second determination unit 440, and the correction information generation unit 543 when the correction information can be updated on the basis of the previous first location information.

First, the case in which the acquisition means identification information related to the acquired correction information indicates the second location information will be described. In this case, the correction information acquisition unit 542 determines that the correction information is likely to be able to be updated to that with a higher accuracy by updating the correction information according to previous first location information. The correction information acquisition unit 542 causes the second determination unit 440 to determine whether or not the correction information can be updated according to the previous first location information.

Subsequently, the second determination unit 440, receiving notification indicating on the likelihood, determines whether or not latest previous first location information has been acquired within a range of a base station with which communication is currently in progress. As this determination, for example, a base station with which communication is in progress is determined to be more likely not to change (or is determined to be the same as a base station with which communication is currently in progress) when a moving distance from the latest previous first location information is less than or equal to a predetermined threshold value (when the moving distance is not far away from the current location). The second determination unit 440 provides a determination result to the correction information generation unit 543, and causes the correction information generation unit 543 to perform a process of determining the latest previous first location information as correction information (a process of generating correction information for an update). The determined correction information is provided to the correction information server 511 and the correction information server 511 updates the correction information.

In addition, when the acquisition means identification information related to the acquired correction information indicates the first location information, the correction information acquisition unit 542 compares the strength of a current reception level to the strength of reception level information acquired along with the correction information, and determines whether or not a current location of the wireless communication device is close to the base station. If the current reception level is strong, the correction information acquisition unit 542 determines that the current location of the wireless communication device is close to the base station, and determines that the accuracy of location is likely to be higher by updating the correction information according to previous first location information. The correction information acquisition unit 542 causes the second determination unit 440 to determine whether or not the previous first location information should be the correction information.

Subsequently, the second determination unit 440, receiving notification indicating on the likelihood, determines whether or not latest previous first location information has been acquired in a location close to the current location of the wireless communication device (a location where a reception level does not greatly change). As this determination, for example, it is determined to have been acquired in a location close to a current location of the wireless communication device if a moving distance from the latest previous first location information is less than or equal to a predetermined threshold value (if the moving distance is not far away from the current location). The second determination unit 440 provides a determination result to the correction information generation unit 543, and causes the correction information generation unit 543 to perform a process of determining the latest previous first location information as the correction information. The determined correction information is provided to the correction information server 511 and the correction information is updated in the correction information server 511.

Like the correction information generation unit 310 described up to FIG. 14, the correction information generation unit 543 generates the correction information. If the previous second location information is determined to be the correction information (the correction information is generated), the correction information generation unit 543 generates the correction information in association with acquisition means identification information indicating that the correction information is generated on the basis of the second location information (derived from the second location information), and provides the correction information to the correction information acquisition unit 542 and the communication unit 230. In addition, if the previous first location information is determined to be the correction information, the correction information generation unit 543 generates the correction information in association with acquisition means identification information indicating that the correction information is generated on the basis of the first location information (derived from the first location information) and reception level information related to the previous first location information. In addition, if the correction information acquisition unit 542 and the second determination unit 440 determine that correction information can be updated with a higher accuracy on the basis of the latest previous first location information, the correction information generation unit 543 determines the latest previous first location information as the correction information. The correction information determined when the update is determined to be possible is provided to the correction information acquisition unit 260 and provided to the correction information server 511 according to wireless communication via the communication unit 230, and the correction information is updated in the correction DB.

The acquisition means identification information and the reception level information are associated along with the correction information as described above, so that the correction information generated by the user closest to the base station is retained in the correction information server 511.

[Update Example of Correction DB in Correction Information Server]

FIG. 16 is a diagram illustrating an example in which a correction DB is updated according to correction information generated by the wireless communication device 540 closer to a base station in the fourth embodiment of the present technology.

In FIG. 16(a), a state in which the wireless communication device 540, detecting that there is no correction information related to a base station (cell ID: d56743) in the correction DB, determines the second location information as the correction information (generates the correction information) and the generated correction information is newly registered is illustrated. In addition, a state in which the correction information registered in FIG. 16(a) is updated is illustrated in FIG. 16(b), and a state in which the correction information updated in FIG. 16(b) is further updated is illustrated in FIG. 16(c).

In FIG. 16(a), a table (table 550) indicating part of the correction DB of a state in which the wireless communication device 540, detecting that there is no correction information in the correction DB, determines the second location information as the correction information and the correction information is newly registered is illustrated.

In FIG. 16(a), the wireless communication device 540 determines to adopt the second location information in a determination of which of the first location information and the second location information is determined to be the correction information.

In the correction DB shown in the table 550, a cell ID (a column 552) indicating a base station of a location management target is associated with acquisition means identification information (a column 553) indicating an acquisition means of location information (correction information) associated with the cell ID. Further, the cell ID (the column 552) is associated with reception level information (a column 554) when the correction information is derived from the first location information and the first location information is acquired. In addition, as in the correction information of the first embodiment of the present technology illustrated in FIG. 4(b), correction information (latitude (a column 555) and longitude (a column 556)) is associated with the cell ID.

In the correction DB shown in the table 550, the newly registered information (information of a cell ID “d56743”) is surrounded by a bold black frame (frame 551). The cell ID “d56743” is associated with acquisition means identification information of a value of 2 indicating that the correction information is derived from the second location information, latitude “35.699999,” and longitude “139.876543.” Because the second location information serves as the correction information in terms of the correction information of the cell ID “d56743,” the reception level information is absent (as indicated by “-” in the drawing).

As described above, when there is no necessary correction information in the correction DB, the wireless communication device 540 newly registers the newly generated correction information in the correction DB in association with the cell ID along with the acquisition means identification information and the reception level information.

In FIG. 16(b), a table (table 560) in which a simplified part of the correction DB of a state in which correction information newly registered in FIG. 16(a) is updated is illustrated. In FIG. 16(b), the updated information is surrounded by a frame 561.

In FIG. 16(b), the correction information of the cell ID “d56743” is updated to latitude “35.685545” and longitude “139.843335.” In addition, the acquisition means identification information is updated to “1” and the reception level information is updated to “−110” dBm.

As described above, the wireless communication device 540 updates information of a base station (cell ID) in the correction DB when the correction information determined according to the second location information is determined to be able to be updated to information closer to an original location by designating the first location information as the correction information. In this update, the acquisition means identification information is updated to a value of “1” indicating the first location information along with the update of the correction information, and the reception level information is updated to a reception level value when the first location information has been acquired.

In FIG. 16(c), a table (table 570) in which a simplified part of the correction DB of a state in which correction information updated in FIG. 16(b) is further updated is illustrated. In FIG. 16(b), the further updated information is surrounded by a frame 571.

In FIG. 16(b), correction information of the cell ID “d56743” is updated to latitude “35.667841” and longitude “139.810067.” In addition, the reception level information is updated to “−66” dBm.

As described above, the wireless communication device 540 updates the correction information if the correction information derived from the first location information is determined to be able to be updated to information closer to an original location by updating the first location information for which a reception signal is strong (close to a base station) as the correction information. In this update, the reception level information is updated to a reception level value when the first location information has been acquired along with the update of the correction information.

[Operation Example of Wireless Communication Device]

Next, an operation example of the wireless communication device 540 in which the correction DB is updated according to correction information generated by the wireless communication device closer to a base station in the fourth embodiment of the present technology will be described with reference to the drawings.

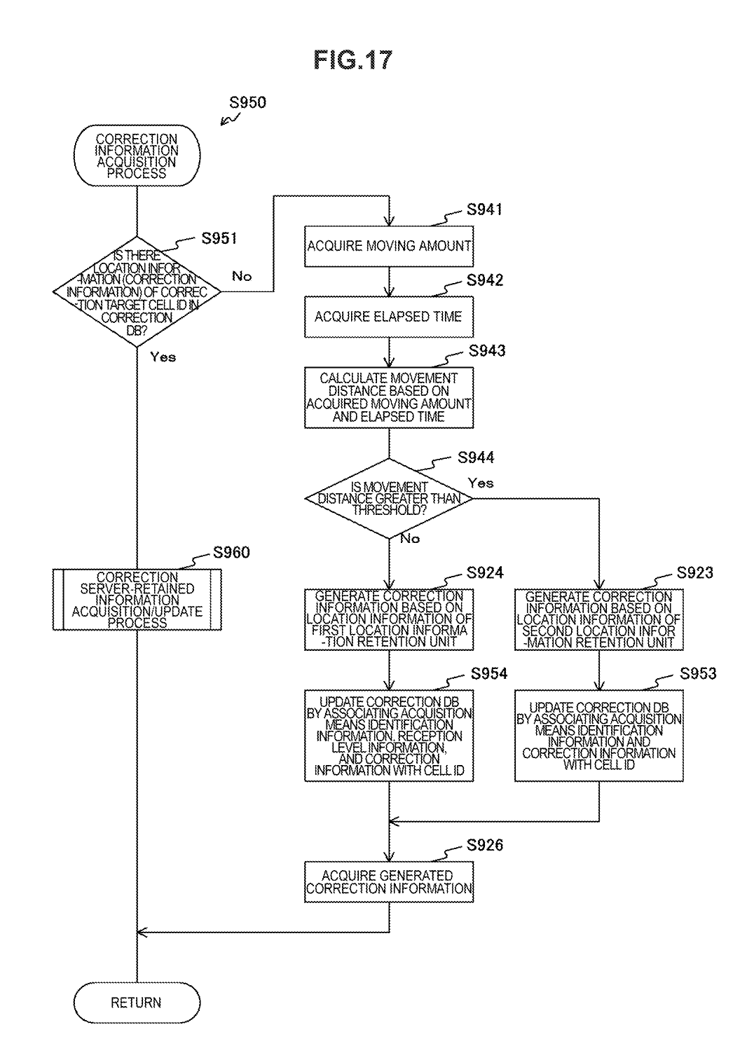

A current location determination processing procedure of the wireless communication device 540 is a modified example of the current location determination processing procedure illustrated in FIG. 10, and the processing content of the correction information acquisition process (step S940) of FIG. 10 is different. In this correction information acquisition process, a process of acquiring correction information from the correction information server 511 and a process of determining whether or not to update the correction information are different from those of the correction information acquisition process (step S940) of FIG. 10. Here, description other than that of the correction information acquisition process (step S950) in the current location determination processing procedure of the wireless communication device 540 is omitted, and an example of a processing procedure of the correction information acquisition process (step S950) will be described with reference to FIG. 17.

FIG. 17 is a flowchart illustrating an example of the processing procedure of the correction information acquisition process (step S950) in a current location determination processing procedure of the wireless communication device 540 of the fourth embodiment of the present technology.

Because the correction information acquisition process (step S950) illustrated in FIG. 17 is a modified example of the correction information acquisition process (step S940) illustrated in FIG. 11, the same procedures are denoted by the same reference numerals and description thereof is omitted here.

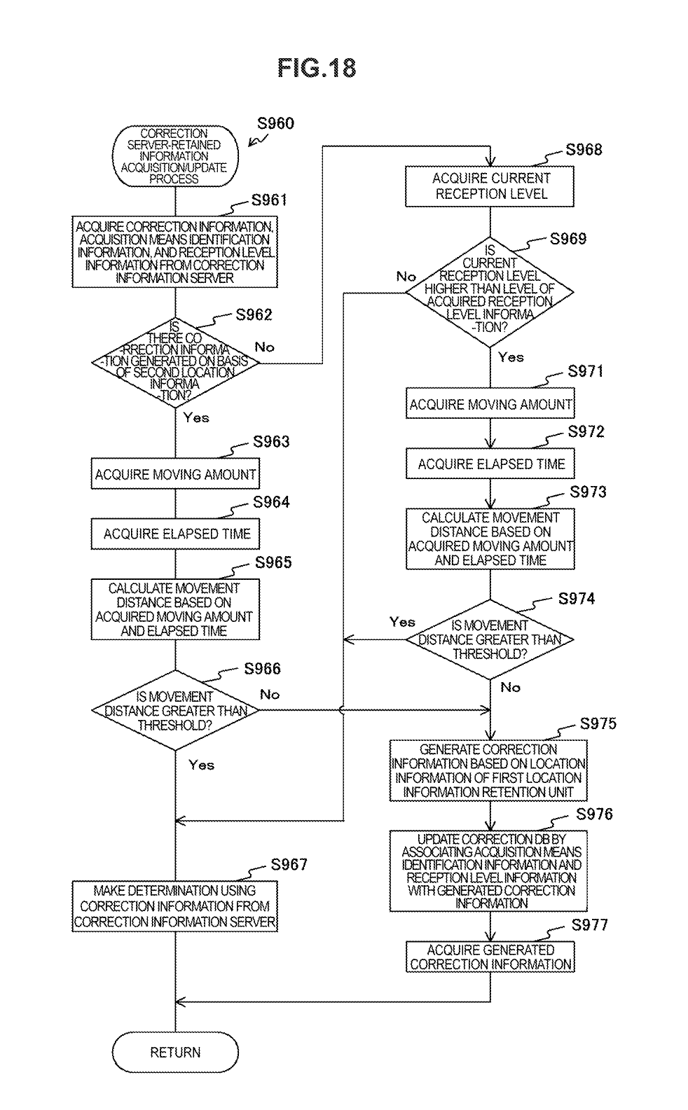

First, the correction information acquisition unit 542 determines whether or not there is correction information corresponding to a cell ID of a base station of a correction target in the correction DB of the correction information server 511 (step S951). If the correction information corresponding to the cell ID is determined to be present (step S951), a correction server-retained information acquisition/update process (step S960) of acquiring the correction information from the correction information server 511 is performed and the correction information acquisition processing procedure ends. The correction server-retained information acquisition/update process (step S960) will be described with reference to FIG. 18.

On the other hand, if the correction information corresponding to the cell ID is determined to be absent (step S951), the procedure proceeds to step S941.

If the moving distance is determined to be greater than the threshold value in step S944, the correction information generation unit 310 determines previous second location information as the correction information (step S923) and then a cell ID associated with the correction information and acquisition means identification information is registered in the correction DB of the correction information server 511 (step S953).

On the other hand, if the moving distance is determined not to be greater than the threshold value in step S944, the correction information generation unit 310 determines the previous first location information as the correction information (step S924) and then the cell ID associated with the correction information, the acquisition means identification information, and the reception level information is registered in the correction information server 511 (step S954).

FIG. 18 is a flowchart illustrating an example of a processing procedure of a correction server-retained information acquisition/update process (step S960) in the current location determination processing procedure of the wireless communication device 540 of the fourth embodiment of the present technology.

First, the correction information acquisition unit 542 acquires correction information, acquisition means identification information, and reception level information associated with a cell ID of a correction target in the correction information server 511 (step S961). Subsequently, on the basis of the acquisition means identification information related to the correction information acquired from the correction information server 511, the correction information acquisition unit 542 determines whether or not the correction information is determined from the second location information (from location acquisition from the cell ID) (step S962).

If the correction information is determined from the second location information (step S962), the second determination unit 440 acquires a moving amount measured by the moving amount measurement unit 420 (step S963). In addition, the second determination unit 440 acquires an elapsed time measured by the elapsed time measurement unit 430 (step S964). Subsequently, on the basis of the acquired moving amount and elapsed time, the second determination unit 440 calculates a moving distance (step S965).

Next, the second determination unit 440 determines whether or not the calculated moving distance is greater than the threshold value (step S966). The determination by the second determination unit 440 is the same as the determination based on the threshold value in the second determination unit 440 illustrated in FIG. 9. As the threshold value, a distance at which a base station (cell ID) with which communication is in progress is set. If the distance is determined not to be greater than the threshold value (if a base station with which communication has been performed during acquisition of latest previous first location information is determined to be the same as the current base station) (step S966), the procedure proceeds to step S975.

On the other hand, if the distance is determined to be greater than the threshold value (step S966), the correction information acquisition unit 542 determines to correct the location information using the correction information acquired from the correction information server 511 (step S967), and the correction server-retained information acquisition/update procedure ends.

If correction information determined from the second location information is determined to be absent (step S962), the correction information acquisition unit 542 acquires a signal level of a currently received signal detected by the radio parameter acquisition unit 541 (step S968). Subsequently, the correction information acquisition unit 542 compares the strength of a current reception level to the strength of reception level information associated with the acquired correction information and determines whether or not the strength of the current reception level is higher (step S969). If the strength of the current reception level is determined not to be higher (step S969), the procedure proceeds to step S967.

On the other hand, if the strength of the current reception level is determined to be higher (step S969), the second determination unit 440 acquires the moving amount measured by the moving amount measurement unit 420 (step S971). In addition, the second determination unit 440 acquires the elapsed time measured by the elapsed time measurement unit 430 (step S972). Subsequently, the second determination unit 440 calculates a moving distance on the basis of the acquired moving amount and elapsed time (step S973).

Next, the second determination unit 440 determines whether or not the calculated moving distance is greater than the threshold value (step S974). In the determination (step S974) by the second determination unit 440, a distance at which a reception level does not greatly change from a current reception level (a distance at which an upper limit is not less than a level of reception level information associated with the correction information) is set as the threshold value. If the distance is determined to be greater than the threshold value (the reception level is determined to be likely to be significantly different because latest previous first location information is too far from a current location) (step S974), the procedure proceeds to step S967.

On the other hand, if the distance is determined not to be greater than the threshold value (step S974), the correction information generation unit 543 generates correction information by determining previous first location information related to a measurement start time (latest previous first location information) as the correction information (step S975). Subsequently, the correction information, the reception level information related to a correction information acquisition time, and the acquisition means identification information are transmitted to the correction information server 511 along with the cell ID, and the correction DB is updated (step S976). In addition, the correction information acquisition unit 542 acquires the generated correction information (step S977), and the correction server-retained information acquisition/update procedure ends.

According to the fourth embodiment of the present technology as described above, even when wrong location information is provided from a server as a location of a base station, the wireless communication device can appropriately determine a current location by acquiring correction information from a correction server.

### 7. Fifth Embodiment

In the first to fourth embodiments of the present technology, an example in which the wireless communication device corrects location information so that an application of the wireless communication device uses the corrected location information has been described. However, the present technology is not limited thereto and correction may be performed in the correction server.

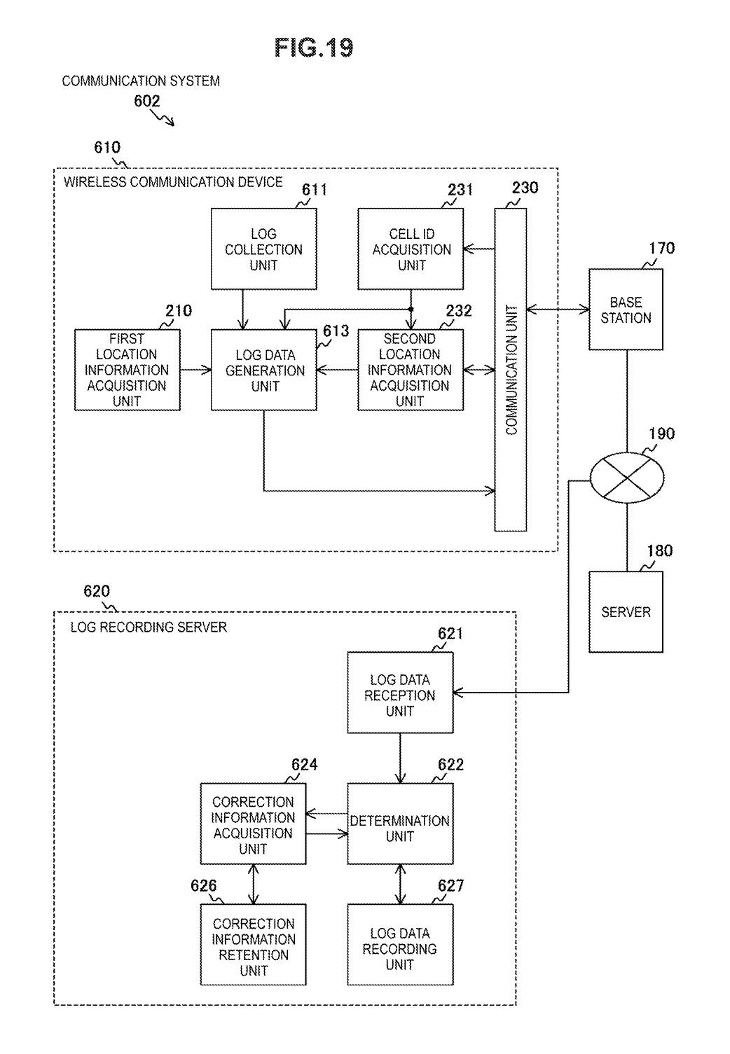

An example in which information regarding a current location acquired by the wireless communication device of the first to fourth embodiment of the present technology is corrected in the correction server will be described with reference to FIGS. 19 to 22.

[Configuration Example of Wireless Communication Device]

FIG. 19 is a block diagram illustrating a configuration example of a communication system 602 in which the server performs a location correction function of the wireless communication device 200 of the first embodiment of the present technology according to the fifth embodiment of the present technology.

The communication system 602 includes a base station 170, a server 180, a public network 190, a wireless communication device 610, and a log recording server 620. Because elements other than the wireless communication device 610 and the log recording server 620 are the same as described so far, description will be given focusing on the wireless communication device 610 and the log recording server 620 here. The log recording server 620 is an example of an information processing device described in the claims.

The wireless communication device 610 is a modified example of the wireless communication device shown in the first to fourth embodiments, and includes a first location information acquisition unit 210, a communication unit 230, a cell ID acquisition unit 231, a second location information acquisition unit 232, a log collection unit 611, and a log data generation unit 613. Here, the newly shown log collection unit 611 and log data generation unit 613 will be described.

The log collection unit 611 collects a log, and provides the log data generation unit 613 with information of content of a log (log content information) along with a log collection time.

The log data generation unit 613 generates log data on the basis of the log content information, location information when the log is collected, and the log collection time. As in the first to fourth embodiments described so far, the first location information is designated as the location information when the log is collected if the first location information acquisition unit 210 can receive a GPS signal and the second location information is designated as the location information if no GPS signal can be acquired. In addition, when the location information acquired by the second location information acquisition unit 232 (location information based on a cell ID) is designated as the location information of the log, the cell ID associated with the location information is also included and the log data is generated. That is, when log data is generated using the first location information as the location information, the log data generation unit 613 generates the log data including at least the log content information, the time, and the location information. In addition, when the second location information is designated as the location information, log data including at least the log content information, the time, the location information, and the cell ID is generated.

In addition, because the accuracy of time is high in terms of the log collection time, a time generated by the first location information acquisition unit 210 may be used when the first location information acquisition unit 210 can generate the location information (because the time calculated on the basis of the GPS signal is most accurate).

The log data generation unit 613 causes the log data to be transmitted to the log recording server 620 by providing the generated log data to the communication unit 230. Log data may be transmitted every time the log data is generated, or the log data may be accumulated for a predetermined time and then collectively transmitted.

The log recording server 620 integrates the log data transmitted from the wireless communication device 610, and includes a log data reception unit 621, a determination unit 622, a correction information acquisition unit 624, a correction information retention unit 626, and a log data recording unit 627.

The log data reception unit 621 receives the log data provided from the wireless communication device 610 via the public network 190. The log data reception unit 621 provides the received log data to the determination unit 622. The log data reception unit 621 is an example of an acquisition unit described in the claims.

The determination unit 622 analyzes whether or not there is wrong location information determined according to the second location information among pieces of location information of the log data. The determination unit 622 calculates a distance (moving distance) between pieces of location information in two arbitrary log data among the log data provided from the log data reception unit 621 and an elapsed time between the two log data. Like the determination unit 280 illustrated in FIG. 3, the determination unit 622 sets the threshold value (upper limit of the distance assumed to be movable) and compares the moving distance to the threshold value.

If the calculated moving distance is greater than the threshold value in this comparison, the correction of the location information is determined to be necessary (association in the server 180 is determined to be wrong). The determination unit 622 provides the correction information acquisition unit 624 with a cell ID included in the log data of a correction target, and causes the correction information acquisition unit 624 to acquire the correction information associated with the cell ID. The determination unit 622 corrects the location information of the log data according to the correction information provided from the correction information acquisition unit 624 acquiring the correction information (the location information of the log data is rewritten to a location indicated by the correction information).

The determination unit 622 provides the log data recording unit 627 with the log data of which the location information has been corrected and records the log data on the log data recording unit 627. The determination unit 622 provides the log data recording unit 627 with the log data of which the location information is not wrong (log data that does not need to be corrected) directly without correction, and records the log data on the log data recording unit 627. As described above, the determination unit 622 performs a function corresponding to the determination unit 280 illustrated in FIG. 3. The determination unit 622 is an example of a detection unit and a correction unit described in the claims.

The correction information acquisition unit 624 acquires correction information related to the cell ID provided from the determination unit 622 from the correction information retention unit 626. The correction information acquisition unit 624 provides the acquired correction information to the determination unit 622. That is, the correction information acquisition unit 624 performs a function corresponding to the correction information acquisition unit 260 illustrated in FIG. 3.

The correction information retention unit 626 retains the correction DB, and corresponds to the correction information retention unit 270 illustrated in FIG. 3.

The log data recording unit 627 records log data. In addition, the log data recording unit 627 provides the determination unit 622 with log data to be used as a calculation start location of a moving distance and an elapsed time when the determination unit 622 makes a determination. For example, data or the like in a life log or the like is considered as log data to be retained by the log data recording unit 627. The log data recorded on the log data recording unit 627 is used in service using a log.

As described above, location information generated on the basis of a cell ID is corrected, so that a user can reduce the effort of correcting location information retained in log data and wrong location information can be prevented from being provided to others viewing a log.

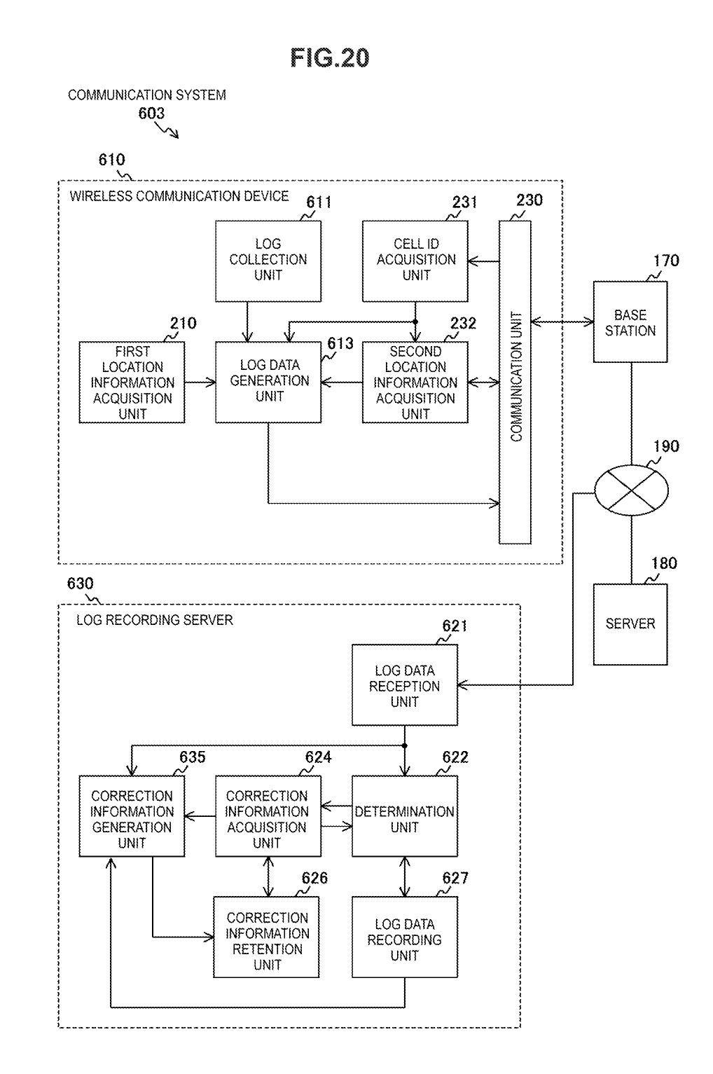

FIG. 20 is a block diagram illustrating a configuration example of a communication system 603 in which the server performs a location correction function of the wireless communication device 300 of the second embodiment of the present technology according to the fifth embodiment of the present technology.

This communication system 603 is a modified example of the communication system 602 illustrated in FIG. 19, and is different from the communication system 602 of FIG. 19 only in that a correction information generation unit 635 is provided in the log recording server (log recording server 630). Here, description will be given focusing on the correction information generation unit 635.

The correction information generation unit 635 generates correction information when there is no correction information necessary for the correction DB of the correction information retention unit 626. When the correction information acquisition unit 624 has not acquired correction information (when there is no correction information in the correction DB), a command (correction information generation command) for causing the correction information to be generated is provided from the correction information acquisition unit 624 to the correction information generation unit 635. If the correction information generation command is provided, the correction information generation unit 635 acquires log data immediately before log data including a cell ID of a correction target from the log data recording unit 627. The correction information generation unit 635 determines correction information for the cell ID by associating the location information of the acquired log data with the cell ID of the correction target. The correction information generation unit 635 provides the correction information retention unit 626 with the determined correction information, and updates the correction DB. In addition, in the determination unit 622, the location information of the log data of the correction target is corrected according to the determined correction information (the location information of the log data is rewritten (updated) to a location indicated by the correction information). That is, the correction information generation unit 635 performs a function corresponding to the correction information generation unit 310 illustrated in FIG. 6.

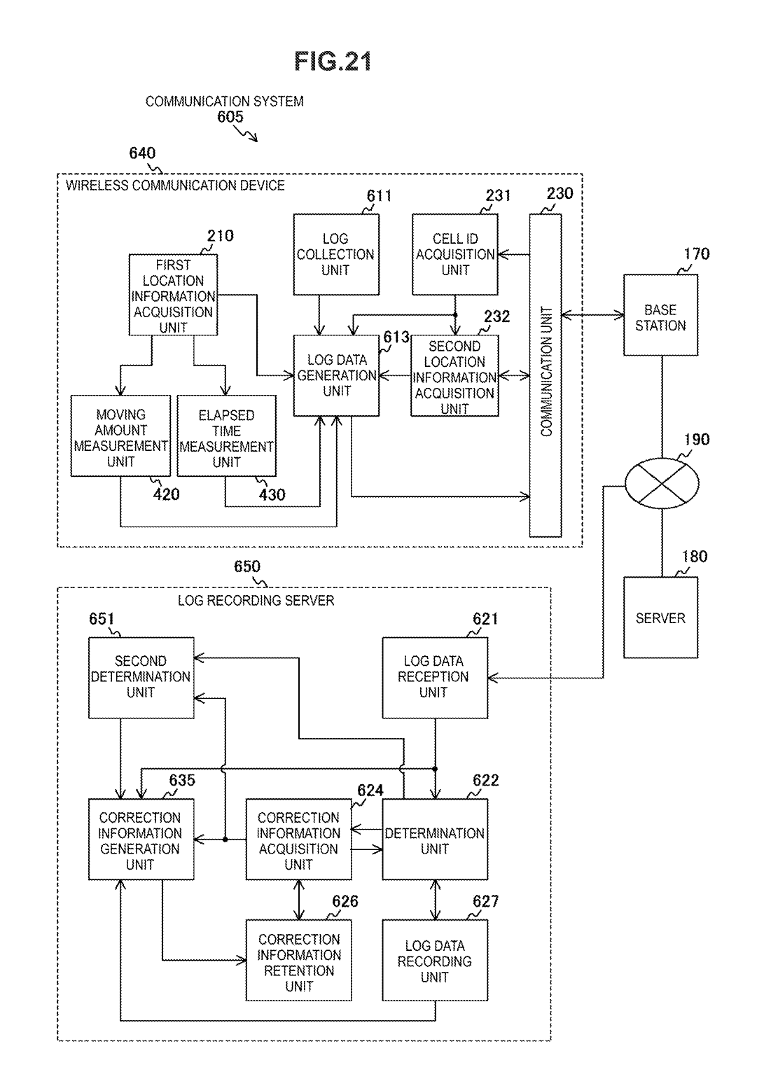

FIG. 21 is a block diagram illustrating a configuration example of a communication system 605 in which the server performs a location correction function of the wireless communication device 400 of the third embodiment of the present technology according to the fifth embodiment of the present technology.

The communication system 605 includes a wireless communication device 640 instead of the wireless communication device 610 illustrated in FIGS. 19 and 20. In addition to the elements of the wireless communication device 610, the wireless communication device 640 includes a moving amount measurement unit 420 and an elapsed time measurement unit 430. Because the moving amount measurement unit 420 and the elapsed time measurement unit 430 are the same as those illustrated in FIG. 9, description thereof is omitted here. In the wireless communication device 640, information (a moving amount and an elapsed time) generated by the moving amount measurement unit 420 and the elapsed time measurement unit 430 are provided to the log data generation unit 613.

The log data generation unit 613 generates a moving distance based on the provided moving amount and elapsed time, and generates log data including the generated moving distance. That is, the log data generation unit 613 generates log data including at least log content information, a time, and location information when determining the location information based on the first location information (using the first location information as the location information) and generating the log data. In addition, when the second location information is designated as the location information, log data including at least log content information, a time, location information, a cell ID, and a moving distance is generated.

The communication system 605 includes a log recording server 650 instead of the log recording servers 620 and 630 illustrated in FIGS. 19 and 20. In addition to the elements of the log recording server 630 of FIG. 20, the log recording server 650 includes a second determination unit 651. Here, description will be given focusing on the second determination unit 651.

When the correction information generation unit 635 generates the correction information, the second determination unit 651 determines which of previous log data generated using the first location information as the location information and previous log data generated using the second location information as the location information is determined to be the correction information. A correction information generation command from the correction information acquisition unit 624, and the moving distance and the elapsed time from the determination unit 622 are provided to the second determination unit 651.

When the correction information generation command has been provided from the correction information acquisition unit 624, the second determination unit 651 acquires the moving distance in log data of a correction target of a location from the determination unit 622 and compares the moving distance to a threshold value. If the moving distance is greater than the threshold value, the location information of log data using the second location information as the location information is determined to be associated with a cell ID of a base station of a correction target, and a determination result is provided to the correction information generation unit 635. In addition, when the moving distance is less than or equal to the threshold value, location information of log data using the first location information as the location information is determined to be associated with the cell ID of the base station of the correction target, and a determination result and the elapsed time are provided to the correction information generation unit 635. This determination is the same as the determination of the second determination unit 440 illustrated in FIG. 9, and the second determination unit 651 performs a function corresponding to the second determination unit 440.

The correction information generation unit 635 determines log data from which a location is referred to on the basis of the determination result provided from the second determination unit 651, and generates correction information. That is, when the log data is referred to using the second location information as the location information, the correction information generation unit 635 generates the correction information by acquiring log data closest to an acquisition time of log data of a correction target among log data using the second location information as the location information from the log data recording unit 627. In addition, when log data generated using the first location information as the location information is referred to, the correction information is generated by acquiring log data, which is earlier than the acquisition time of the log data of the correction target by the elapsed time, from the log data recording unit 627.

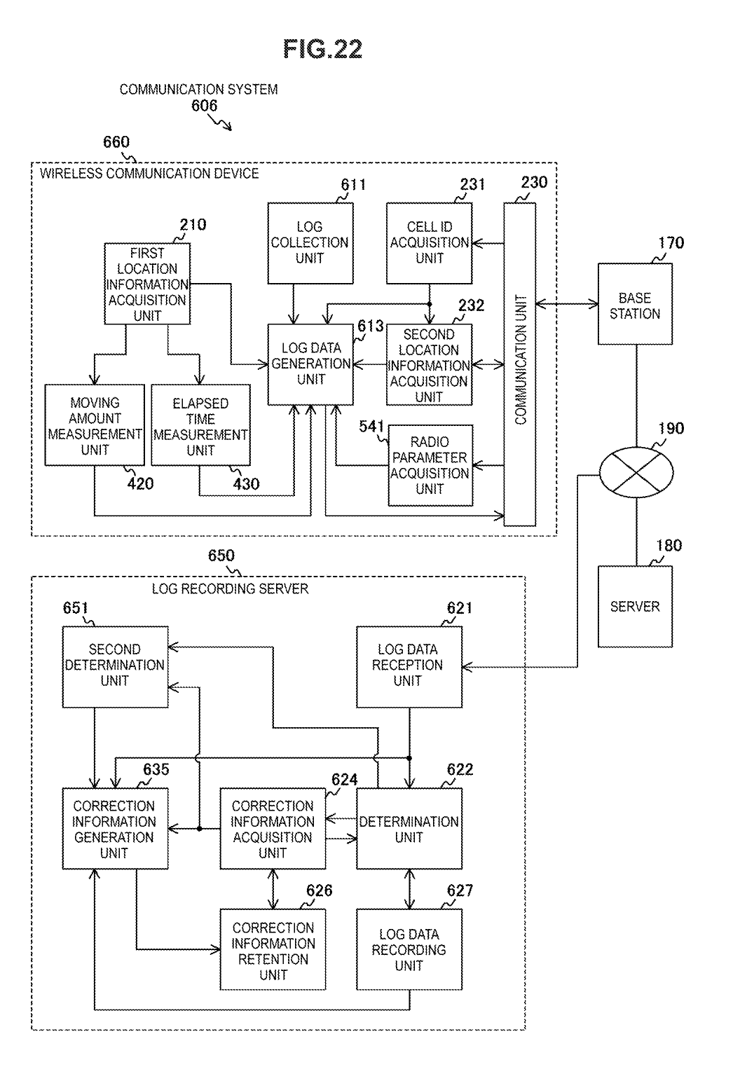

FIG. 22 is a block diagram illustrating a configuration example of a communication system 606 in which the server performs a location correction function of the wireless communication device 540 of the fourth embodiment of the present technology according to the fifth embodiment of the present technology.

In addition to the elements of the wireless communication device 640 illustrated in FIG. 21, a wireless communication device 660 of the communication system 606 includes a radio parameter acquisition unit 541. Because the radio parameter acquisition unit 541 is the same as that illustrated in FIG. 15, description thereof is omitted here.

In addition, when log data is generated using the first location information, the log data generation unit 613 of the wireless communication device 660 generates log data including at least log content information, a time, location information, and reception level information.

Because the determination unit 622, the correction information generation unit 635, and the correction information acquisition unit 624 in the log recording server 650 and the use of reception level information in the second determination unit 651 are the same as the elements illustrated in FIG. 15, description thereof is omitted here.

According to the fifth embodiment of the present technology as described above, it is possible to appropriately determine a location of a wireless communication device by arranging and correcting location information detected by the wireless communication device in the server that accumulates (records) the location information.

### 8. Sixth Embodiment

In the first to fifth embodiments of the present technology, an example in which location information associated with a cell ID is provided from the server 180 has been described. However, the present technology is not limited thereto, and a wireless communication device may retain the location information associated with the cell ID.

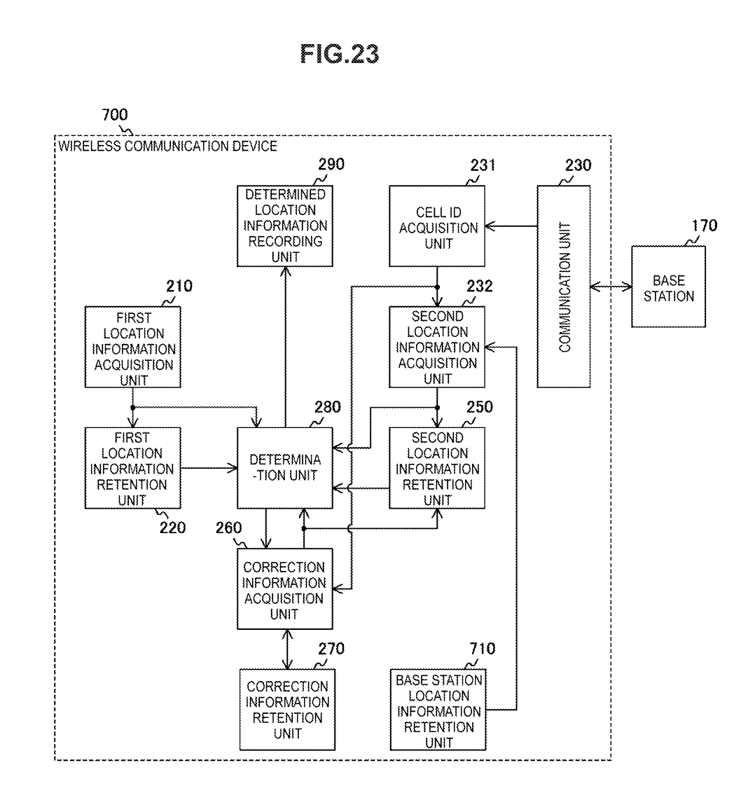

In the sixth embodiment of the present technology, an example in which the location information associated with the cell ID is retained in the wireless communication device will be described with reference to FIG. 23.

[Configuration Example of Wireless Communication Device]

FIG. 23 is a block diagram illustrating a configuration example of a wireless communication device 700 of the sixth embodiment of the present technology.

The wireless communication device 700 is shown in the sixth embodiment of the present technology as a modified example of the wireless communication device 200 of the first embodiment of the present technology illustrated in FIG. 3, and other embodiments are omitted.

In addition to the elements of the wireless communication device 200 illustrated in FIG. 3, the wireless communication device 700 includes a base station location information retention unit 710.

The base station location information retention unit 710 retains a DB retained by the server 180 illustrated in FIG. 3 (a DB in which cell IDs are associated with location information). Although various parameters are considered in a method in which the base station location information retention unit 710 retains information to be retained, for example, all information is retained when an application using the location information is installed in the wireless communication device 200. Alternatively, only information of a base station within a predetermined range from a current location (within a range in which movement is predicted) is downloaded and retained when an application use is started.

When the location information of the base station is acquired, the second location information acquisition unit 232 acquires the location information from the DB retained in the base station location information retention unit 710. Thereby, it is possible to obtain the location information of the base station from a cell ID even when a DB server (see the server 180 of FIG. 3) is not provided.

According to the sixth embodiment of the present technology as described above, the wireless communication device can appropriately determine the current location even when the wireless communication device retains location information associated with a cell ID.

According to the embodiment of the present technology as described above, the wireless communication device appropriately corrects location information generated on the basis of a cell ID (identification information of a base station) using a correction DB, thereby appropriately determining a location (location information) of the wireless communication device.

Although an example in which a location of a base station with which communication is currently in progress is designated as second location information has been described in the embodiment of the present technology, the present technology is not limited thereto. A location relatively calculated on the basis of the location information of the base station around the wireless communication device and the strength of a pilot signal from a peripheral base station may be designated as the second location information. For example, the wireless communication device acquires a cell ID of a peripheral base station of the wireless communication device and the strength of a pilot signal from each base station by performing a cell search that searches for a peripheral cell at the timing when the second location information is acquired. The wireless communication device acquires location information of the peripheral base station on the basis of the acquired cell ID. Thereafter, the wireless communication device may relatively calculate a current location from a location of each of peripheral base stations and the strength of a pilot signal from each base station and designate the calculated location as the second location information.

In this case, when the determination unit 280 also determines that the second location information is wrong, correction is appropriately performed using the correction DB. In this correction, for example, if the second location information is determined to be wrong, a wrongly associated cell ID is searched for from among cell IDs used when the second location information is calculated, and the second location information is recalculated after appropriate correction using the correction DB. Alternatively, if the calculated second location information is determined to be wrong, a location of a base station with which current communication is performed is instead designated as the second location information. If this second location information is also determined to be wrong, correction is appropriately performed using the correction DB. As described above, it is possible to appropriately determine a location (location information) of a wireless communication device by appropriately correcting the second location information using the correction DB.

Although the first location information acquisition unit 210 has been assumed to acquire location information from only a GPS signal in the embodiment of the present technology, the present technology is not limited thereto. Because power consumption is large in the calculation of the location from the GPS signal, battery power of the wireless communication device is consumed rapidly. The case in which the number of GPS signal acquisitions is reduced may also be considered.

For example, the first location information may be generated using both an acceleration sensor and the gyro sensor. In this example, a method of calculating a location based on a moving distance and a moving direction detected by the sensors using location information acquired by a GPS signal as a reference location within a predetermined time (or a predetermined distance) from a location where the location information has been acquired according to the GPS signal may be considered. Even when the calculated location is designated as the first location information, it is possible to appropriately determine the current location according to the same method as in the embodiment of the present technology.

In addition, the case in which the first location information acquisition unit 210 is set so that the last location information detected according to a GPS signal is designated as currently detected location information (first location information) for a predetermined time (depending upon a moving speed) in which no GPS signal is received may also be considered.

In addition, although the second location information acquisition unit 232 has been assumed to acquire the location information when the first location information acquisition unit 210 does not acquire the location information, the present technology is not limited thereto. For example, the second location information acquisition unit 232 may acquire location information to reduce power consumption without receiving a GPS signal even when the GPS signal can be received so as to suppress the power consumption when a reception level of a radio signal is high. In this case, it is also possible to appropriately determine a current location according to the same method as in the embodiment of the present technology.

As a threshold value to be used in the second determination unit 440, an appropriate value may be set according to a wireless communication method or a current location (an urban area in which the number of base stations having a small cell range is large or a rural area in which the number of base stations having a large cell range is large).

In addition, although a communication means when location information of a base station is acquired from a server has been assumed to be a wireless type via the base station in the embodiments of the present technology, the present technology is not limited thereto. For example, the acquisition may also be performed via a communication means separate from the communication means acquiring the identification information of the base station (for example, communication with a wireless communication device connected to a home Internet connection service (in a wired type)).

Although only a distance determination by the determination unit 280 has been described, the present technology is not limited thereto. For example, when a period of time from an acquisition time of latest previous location information to an acquisition time of current second location information is long (for example, greater than or equal to 60 minutes), the current second location information may also be designated as current location information when the validation of the determination according to the threshold value is determined to be low.

The above-described embodiments are examples for implementing the present technology. Particulars in the embodiments correspond to specific particulars in the claims. Likewise, the specific particulars in the claims correspond to particulars in the embodiments of the present technology having the same names. However, the present technology is not limited to the embodiments, and various modifications may be implemented without departing from the scope of the present technology.

In addition, the series of processing procedures described in the above-described embodiments may be understood as a method including the above-described series of processing procedures, a program for causing a computer to execute the series of processing procedures, or a recording medium storing the program. As the recording medium, for example, a hard disk, a compact disc (CD), a mini-disc (MD), a digital versatile disc (DVD), a memory card, a Blu-ray disc (registered trademark), and the like can be used.

The present technology can have the following configurations.

(1) A wireless communication device includes: a detection unit for detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and a determination unit for determining a current location based on the first or second location information, and determining the current location based on other location information specified by a base station related to the second location information when the first location information has not been acquired at a timing of the determination and the error of the second location information acquired at the timing of the determination has been detected.

(2) In the wireless communication device according to (1), information from a base station serving as the connection target is identification information of the base station. The wireless communication device further includes: an acquisition unit for acquiring, as the other location information, location information associated with the identification information of the base station related to the second location information of which an error has been detected by the detection unit from a correction DB in which the identification information and the location information are associated and recorded.

(3) The wireless communication device according to (2) further includes: a generation unit for generating the other location information using the first or second location information acquired at the timing before the timing of the determination when the acquisition unit is not able to acquire the other location information from the correction DB.

(4) In the wireless communication device according to (3), the generation unit generates the other location information using latest location information among pieces of the first and second location information acquired at the timing before the timing of the determination.

(5) In the wireless communication device according to (3), the generation unit generates the other location information based on latest first location information if a moving distance of the wireless communication device from an acquisition time of the latest first location information among pieces of the first location information acquired until the timing of the determination till the timing of the determination is short on the basis of a threshold value, and generates the other location information using latest second location information among pieces of the second location information acquired at the timing before the acquisition time of the second location information acquired at the timing of the determination if the moving distance is long on the basis of the threshold value.

(6) In the wireless communication device according to (3), the generation unit updates the correction DB by associating and newly recording the generated other location information and the identification information related to the other location information.

(7) In the wireless communication device according to (6), the correction DB has recorded thereon attribute information indicating the first or second location information used when the location information has been generated, the attribute information being associated for each piece of identification information, and the generation unit generates the other location information using the first location information acquired within a predetermined distance from a location of the wireless communication device at the timing of the determination among pieces of the first location information acquired at the timing before the acquisition time of the second location information acquired at the timing of the determination when the attribute information associated with the other location information acquired by the acquisition unit indicates the second location information, and updates the correction DB by associating and newly recording the other location information, the identification information related to the other location information, and the attribute information.

(8) In the wireless communication device according to (7), the correction DB has signal strength information indicating strength of a radio signal from a base station, the signal strength information being further associated with each piece of the identification information associated with the attribute information indicating the first location information, and the generation unit generates the other location information using the first location information acquired within a predetermined distance from a location of the wireless communication device at the timing of the determination if signal strength is high at the timing of the determination on the basis of the signal strength indicated by the signal strength information associated with the other location information acquired by the acquisition unit, and updates the correction DB by associating and newly recording the other location information, the identification information related to the other location information, the attribute information, and the signal strength information when the first location information has been generated.

(9) In the wireless communication device according to any one of (2) to (8), the acquisition unit acquires the other location information from a correction information server retaining the correction DB.

(10) In the wireless communication device according to any one of (2) to (8), the acquisition unit acquires the other location information from the correction DB recorded in a storage unit embedded in or attached to the wireless communication device.

(11) In the wireless communication device according to any one of (2) to (10), the determination unit corrects the second location information according to the other location information acquired on the basis of the identification information of the base station related to the second location information of which an error has been detected by the detection unit, and determines the current location using the corrected second location information.

(12) In the wireless communication device according to any one of (1) to (11), the detection unit calculates a distance and an elapsed time between the second location information acquired at the timing of the determination and latest location information among pieces of the first and second location information acquired at the timing before the timing of the determination, and determines that the second location information acquired at the timing of the determination is wrong if the distance is greater than a threshold value on the basis of the threshold value set according to the elapsed time.

(13) The wireless communication device according to any one of (1) to (12) further includes: a first acquisition unit for acquiring the first location information; and a second acquisition unit for acquiring the second location information only when the first acquisition unit is not able to acquire the first location information.

(14) An information processing device includes: an acquisition unit for acquiring location information including at least one of pieces of first location information periodically or aperiodically generated on the basis of information from an artificial satellite and second location information periodically or aperiodically generated on the basis of information from a base station serving as a connection target from a wireless communication device; a detection unit for detecting an error of the second location information by comparing the second location information among pieces of the location information acquired by the acquisition unit to the first or second location information acquired at a timing before an acquisition time of the second location information on a time axis; a correction unit for correcting the second location information of which the error has been detected on the basis of other location information specified by a base station related to the second location information when the detection unit has detected the error; and a recording unit for recording the location information acquired by the acquisition unit as a history and recording the second location information corrected by the correction unit as the history when the error has been detected by the detection unit.

(15) An information processing device includes: a reception unit for receiving a correction information request from a wireless communication device, which detects an error of second location information, when the wireless communication device has detected the error by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and a providing unit for providing the wireless communication device with location information retained in association with a base station related to the second location information as correction information when the correction information request has been received.

(16) A communication system includes: a wireless communication device including a detection unit for detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and a determination unit for determining a current location based on the first or second location information, and determining the current location based on other location information specified by a base station related to the second location information when the first location information has not been acquired at a timing of the determination and the error of the second location information acquired at the timing of the determination has been detected; and a server for providing the wireless communication device with substitute location information for a location of the base station indicated by the second location information as the other location information on the basis of a correction information request command provided when the error has been detected by the wireless communication device.

(17) A location determination method includes: detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and determining a current location based on the first or second location information, and determining the current location based on other location information specified by a base station related to the second location information when the first location information has not been acquired at a timing of the determination and the error of the second location information acquired at the timing of the determination has been detected.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-111949 filed in the Japan Patent Office on May 19, 2011, the entire content of which is hereby incorporated by reference.

What is claimed is:

1. A wireless communication device comprising:
a detection unit for detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and
a determination unit for determining a current location based on the first or second location information, and determining the current location based on other location information specified by a base station related to the second location information when the first location information has not been acquired at a timing of the determination and the error of the second location information acquired at the timing of the determination has been detected.

2. The wireless communication device according to claim 1, wherein:
information from a base station serving as the connection target is identification information of the base station, and
the wireless communication device further comprises:
an acquisition unit for acquiring, as the other location information, location information associated with the identification information of the base station related to the second location information of which an error has been detected by the detection unit from a correction database (DB) in which the identification information and the location information are associated and recorded.

3. The wireless communication device according to claim 2, further comprising:
a generation unit for generating the other location information using the first or second location information acquired at the timing before the timing of the determination when the acquisition unit is not able to acquire the other location information from the correction DB.

4. The wireless communication device according to claim 3, wherein the generation unit generates the other location information using latest location information among pieces of the first and second location information acquired at the timing before the timing of the determination.

5. The wireless communication device according to claim 3, wherein the generation unit generates the other location information based on latest first location information if a moving distance of the wireless communication device from an acquisition time of the latest first location information among pieces of the first location information acquired until the timing of the determination till the timing of the determination is short on the basis of a threshold value, and generates the other location information using latest second location information among pieces of the second location information acquired at the timing before the acquisition time of the second location information acquired at the timing of the determination if the moving distance is long on the basis of the threshold value.

6. The wireless communication device according to claim 3, wherein the generation unit updates the correction DB by associating and newly recording the generated other location information and the identification information related to the other location information.

7. The wireless communication device according to claim 6, wherein:
the correction DB has recorded thereon attribute information indicating the first or second location information used when the location information has been generated, the attribute information being associated for each piece of identification information, and
the generation unit generates the other location information using the first location information acquired within a predetermined distance from a location of the wireless communication device at the timing of the determination among pieces of the first location information acquired at the timing before the acquisition time of the second location information acquired at the timing of the determination when the attribute information associated with the other location information acquired by the acquisition unit indicates the second location information, and updates the correction DB by associating and newly recording the other location information, the identification information related to the other location information, and the attribute information.

8. The wireless communication device according to claim 7, wherein:
the correction DB has signal strength information indicating strength of a radio signal from a base station, the signal strength information being further associated with each piece of identification information associated with the attribute information indicating the first location information, and
the generation unit generates the other location information using the first location information acquired within a predetermined distance from a location of the wireless communication device at the timing of the determination if signal strength is high at the timing of the determination on the basis of the signal strength indicated by the signal strength information associated with the other location information acquired by the acquisition unit, and updates the correction DB by associating and newly recording the other location information, the identification information related to the other location information, the attribute information, and the signal strength information when the first location information has been generated.

9. The wireless communication device according to claim 2, wherein the acquisition unit acquires the other location information from a correction information server retaining the correction DB.

10. The wireless communication device according to claim 2, wherein the acquisition unit acquires the other location information from the correction DB recorded in a storage unit embedded in or attached to the wireless communication device.

11. The wireless communication device according to claim 2, wherein the determination unit corrects the second location information according to the other location information acquired on the basis of the identification information of the base station related to the second location information of which an error has been detected by the detection unit, and determines the current location using the corrected second location information.

12. The wireless communication device according to claim 1, wherein the detection unit calculates a distance and an elapsed time between the second location information acquired at the timing of the determination and latest location information among pieces of the first and second location information acquired at the timing before the timing of the determination, and determines that the second location information acquired at the timing of the determination is wrong if the distance is greater than a threshold value on the basis of the threshold value set according to the elapsed time.

13. The wireless communication device according to claim 1, further comprising:
a first acquisition unit for acquiring the first location information; and
a second acquisition unit for acquiring the second location information only when the first acquisition unit is not able to acquire the first location information.

14. An information processing device comprising:
an acquisition unit for acquiring location information including at least one of pieces of first location information periodically or aperiodically generated on the basis of information from an artificial satellite and second location information periodically or aperiodically generated on the basis of information from a base station serving as a connection target from a wireless communication device;
a detection unit for detecting an error of the second location information by comparing the second location information among pieces of the location information acquired by the acquisition unit to the first or second location information acquired at a timing before an acquisition time of the second location information on a time axis;
a correction unit for correcting the second location information of which the error has been detected on the basis of other location information specified by a base station related to the second location information when the detection unit has detected the error; and
a recording unit for recording the location information acquired by the acquisition unit as a history and recording the second location information corrected by the correction unit as the history when the error has been detected by the detection unit.

15. An information processing device comprising:
a reception unit for receiving a correction information request from a wireless communication device, which detects an error of second location information, when the wireless communication device has detected the error by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and
a providing unit for providing the wireless communication device with location information retained in association with a base station related to the second location information as correction information when the correction information request has been received.

16. A communication system comprising:
a wireless communication device including
a detection unit for detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and
a determination unit for determining a current location based on the first or second location information, and determining the current location based on other location information specified by a base station related to the second location information when the first location information has not been acquired at a timing of the determination and the error of the second location information acquired at the timing of the determination has been detected; and
a server for providing the wireless communication device with substitute location information for a location of the base station indicated by the second location information as the other location information on the basis of a correction information request command provided when the error has been detected by the wireless communication device.

17. A location determination method comprising:
detecting an error of second location information by designating location information periodically or aperiodically acquired on the basis of information from an artificial satellite as first location information, designating location information periodically or aperiodically acquired on the basis of information from a base station serving as a connection target as the second location information, and comparing the second location information to the first or second location information acquired at a timing before an acquisition time of the second location information on a time axis; and
determining a current location based on the first or second location information, and determining the current location based on other location information specified by a base station related to the second location information when the first location information has not been acquired at a timing of the determination and the error of the second location information acquired at the timing of the determination has been detected.
